(19) United States
(12) Patent Application Publication
(10) Pub. No.: US 2025/0075091 A1
(43) Pub. Date: Mar. 6, 2025

(54) INK SET, INK JET RECORDING METHOD, INK JET RECORDING APPARATUS, AND MAINTENANCE LIQUID

(71) Applicant: CANON KABUSHIKI KAISHA, Tokyo (JP)

(72) Inventors: MINAKO KAWABE, Tokyo (JP); HIROSHI TOMIOKA, Tokyo (JP); SHINYA YUMOTO, Kanagawa (JP)

(21) Appl. No.: 18/819,630

(22) Filed: Aug. 29, 2024

(30) Foreign Application Priority Data
Aug. 30, 2023 (JP) 2023-140546
Aug. 6, 2024 (JP) 2024-129770

(51) Int. Cl. C09D 11/54; B41J 2/165; C09D 11/322

(52) U.S. Cl. CPC C09D 11/54; B41J 2/16552; C09D 11/322; B41J 2002/16558

(57) ABSTRACT

An ink set includes an aqueous ink and a maintenance liquid used together with the aqueous ink. The aqueous ink contains a pigment, and a resin particle having an anionic group, the pigment and the resin particle being dispersed by the action of the anionic group. The maintenance liquid contains an aminosulfonic acid.

### BACKGROUND

### Field

The present disclosure relates to an ink set, an ink jet recording method, an ink jet recording apparatus, and a maintenance liquid.

### Description of the Related Art

In recent years, the use of ink jet recording apparatuses has been increasing in the fields of office printing and commercial printing. Ink jet recording apparatuses are required to be capable of recording images with excellent fastness, such as abrasion resistance, and to be reliable enough for stable image formation without ink discharge failure even when used continuously over a long period of time.

One method for achieving both excellent abrasion resistance and reliability is to use a maintenance liquid. For example, Japanese Patent Laid-Open No. 2021-17536 discloses a method in which a maintenance liquid containing a solvent that satisfies a predetermined boiling point and solubility parameter (SP) value and amino acid is used for an ink containing a resin and a pigment.

### SUMMARY

The present disclosure is directed to providing an ink set including an aqueous ink and a maintenance liquid, the ink set being reliable, in particular, unlikely to cause ink discharge failure even when used continuously over a long period of time, and being capable of stably forming an image having good abrasion resistance. The present disclosure is also directed to providing an ink jet recording method using this ink set, and an ink jet recording apparatus and the maintenance liquid that can be used for the ink jet recording method.

One disclosed aspect of the embodiments is directed to providing an ink set including an aqueous ink and a maintenance liquid used together with the aqueous ink. The aqueous ink contains a pigment, and a resin particle having an anionic group, the pigment and the resin particle being dispersed by action of the anionic group. The maintenance liquid contains an aminosulfonic acid.

Further features of the present disclosure will become apparent from the following description of exemplary embodiments with reference to the attached drawings.

### BRIEF DESCRIPTION OF THE DRAWINGS

FIG. 1 is a schematic view illustrating an ink jet recording apparatus according to an embodiment of the present disclosure.

FIG. 2 is a perspective view illustrating an example of a liquid applying device.

FIG. 3 is a sectional perspective view illustrating an example of a discharge element substrate.

FIG. 4 is a schematic view illustrating an example of a liquid supply system.

FIG. 5 is a perspective view illustrating an example of a capping tray.

FIG. 6 is a perspective view illustrating an example of a cleaning tray.

FIG. 7 is a schematic view illustrating an example of the supply system of a maintenance device.

FIG. 8 is a perspective view illustrating an example of a cleaning unit.

FIG. 9A is a perspective view illustrating an example of a maintenance liquid applying device.

FIG. 9B is a sectional view taken along line IXB-IXB of FIG. 9A that illustrates an example of the maintenance liquid applying device.

FIG. 9C is a sectional view taken along line IXC-IXC of FIG. 9A that illustrates an example of the maintenance liquid applying device.

FIG. 10 is a schematic view illustrating an example of the positional relationship between the liquid applying device and the cleaning unit.

FIGS. 11A to 11C are schematic views illustrating an example of a cleaning operation.

FIG. 12 is a schematic view illustrating another example of a heating portion.

FIG. 13 is a schematic view illustrating another example of a fixing portion.

### DESCRIPTION OF THE EMBODIMENTS

The inventors conducted studies using the ink and maintenance liquid disclosed in Japanese Patent Laid-Open No. 2021-17536 for the purpose of achieving both abrasion resistance and reliability. As a result, it was found that, regarding the reliability, ink discharge failure occurred in the case of continuous use over a long period of time, thereby failing to achieve stable image formation.

The inventors have conducted intensive studies on an ink set including an aqueous ink and a maintenance liquid, the ink set being reliable, in particular, unlikely to cause ink discharge failure even when used continuously over a long period of time and being capable of stably forming an image having good abrasion resistance, an ink jet recording method using this ink set, and an ink jet recording apparatus and the maintenance liquid that can be used in this ink jet recording method, and have arrived at the present disclosure.

The present disclosure will be described in more detail below with reference to embodiments. In an embodiment of the present disclosure, when a compound is a salt, the salt in an ink is present in the form of dissociated ions. However, for convenience, it is referred to as “the ink contains the salt”. An aqueous ink and a reaction liquid for ink jet recording are also referred to simply as an “ink” and a “reaction liquid”, respectively. Unless otherwise specified, physical property values are values at room temperature (25° C.). The term “(meth)acrylic acid” refers to “acrylic acid” and “methacrylic acid”. The term “(meth)acrylate” refers to “acrylate” and “methacrylate”.

In an ink jet recording method, when an aqueous ink containing a pigment and a resin particle having an anionic group, the pigment and the resin particle being dispersed by action of the anionic group, is used continuously over a long period of time, the cause of discharge failure is thought to be as follows: An ink mist generated during recording adheres to the discharge port surface (port face) of a recording head serving as an ink applying device. Evaporation of water in the ink mist and an increase in the temperature of the recording head during recording lead to the formation of the sticking matter of a mixture of a pigment and a resin particle.

The sticking matter blocks the discharge port of the recording head, causing ink discharge failure. At this time, the resin particle turns into a film, resulting in a film-like sticking matter. The sticking matter of the mixture of a pigment and a resin particle has extremely low dispersibility in the maintenance liquid, compared with the sticking matter of only a pigment. For this reason, it is difficult to remove the sticking matter using a maintenance liquid.

The inventors have conducted studies on a maintenance liquid that can peel off the above-mentioned sticking matter of the mixture of a pigment and a resin from the discharge port surface of the recording head, disperse the sticking matter in the maintenance liquid, and then remove the sticking matter by wiping or applying a negative pressure (suction operation).

The inventors have focused on a material used in a maintenance liquid and have found that the use of the maintenance liquid containing an aminosulfonic acid, which is a compound with a sulfo group and an amino group in its molecule, is effective. The reasons for this are considered as described below.

The anionic group is exposed on the surface of the sticking matter formed of a pigment and a resin particle, the pigment and the resin particle being dispersed by action of the anionic group. The amino group of the aminosulfonic acid in the maintenance liquid interacts with the anionic group, and thus the aminosulfonic acid acts on the surface of the sticking matter, thereby resulting in the attachment of the sulfo group to the surface of the sticking matter. The effect of the sulfo group improves the dispersibility of the sticking matter to allow the sticking matter to easily disperse in the maintenance liquid and weakens the adhesion of the sticking matter to the discharge port surface, making it easier to remove the sticking matter by wiping or a suction operation. Although there are other compounds having anionic and cationic groups, such as amino acids, the acid dissociation constant of the sulfo group is small, even smaller than those of a carboxy group and a hydroxy group. For this reason, the sulfo group can improve the dispersibility of the sticking matter more than other compounds. Therefore, ink discharge failure is unlikely to occur, so that stable image formation can be performed.

### Ink Set, Ink Jet Recording Method and Ink Jet Recording Apparatus

An ink set according to an embodiment of the present disclosure (hereinafter, also referred to simply as an “ink set”) is an ink set including an aqueous ink and a maintenance liquid used together with the aqueous ink. An ink jet recording method according to an embodiment of the present disclosure (hereinafter, also referred to simply as a “recording method”) is an ink jet recording method that uses an ink set including an aqueous ink and a maintenance liquid used together with the aqueous ink. An ink jet recording apparatus (hereinafter, also referred to simply as a “recording apparatus”) according to an embodiment of the present disclosure is an ink jet recording apparatus equipped with an ink set including an aqueous ink and a maintenance liquid used together with the aqueous ink. The aqueous ink in the ink set contains a pigment and a resin particle having an anionic group, the pigment and the resin particle being dispersed by action of the anionic group. The maintenance liquid in the ink set contains an aminosulfonic acid.

### Ink Jet Recording Apparatus

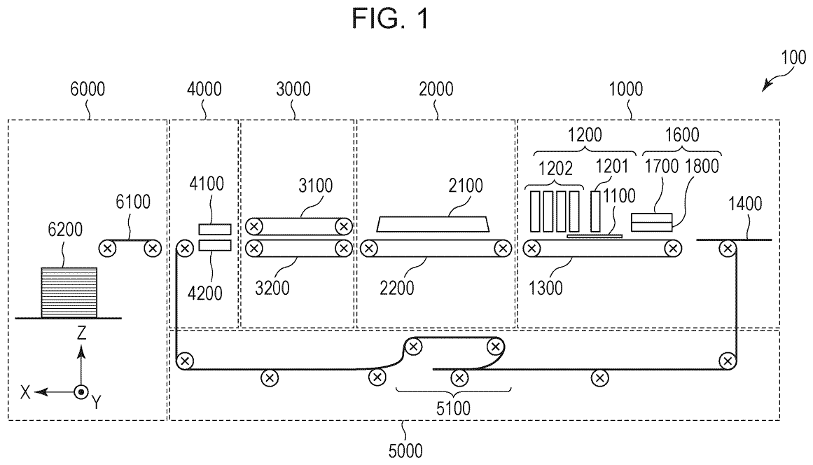

An ink jet recording apparatus will be described in detail below with reference to the drawings. FIG. 1 is a schematic view illustrating an ink jet recording apparatus according to an embodiment of the present disclosure. The ink jet recording apparatus according to the present embodiment is an ink jet recording apparatus that records an image on a recording medium using an ink and a reaction liquid containing a reactant that reacts with the ink. An X-direction, a Y-direction and a Z-direction represent the width direction (total length direction), depth direction and height direction of the ink jet recording apparatus, respectively. The recording medium is conveyed in the X-direction.

An ink jet recording apparatus 100 of the present embodiment illustrated in FIG. 1 includes a recording portion 1000, a heating portion 2000, a fixing portion 3000, a cooling portion 4000, a reversing portion 5000 and a sheet delivery portion 6000. In the recording portion 1000, various liquids are applied to a recording medium 1100, which has been conveyed from a sheet feeding device 1400 by a conveying member 1300, by a liquid applying device 1200. In the heating portion 2000, the liquids applied to the recording medium 1100 are heated by a heating device 2100 to evaporate volatile components, such as water, in the liquids, thereby performing drying. In the fixing portion 3000, a fixing member 3100 is brought into contact with the region of the recording medium 1100, to which the liquids have been applied, to heat the region, to thereby promote the fixation of an image to the recording medium 1100. The recording medium 1100 is then cooled by the cooling member 4100 of the cooling portion 4000. When an image is to be recorded on the rear surface of the recording medium subsequently to the front surface (recording surface) thereof, first, the recording medium 1100 is reversed by the reversing device 5100 of the reversing portion 5000. After the image is recorded on the rear surface as in the case of the front surface, the recording medium is conveyed by the conveying member 6100 of the sheet delivery portion 6000 and stacked and stored in a recording medium storage portion 6200. A maintenance device 1600 recovers the liquid application performance of the liquid applying device 1200. Herein, description is given by taking a configuration including the heating portion 2000 and the fixing portion 3000 as an example. However, the heating portion or the fixing portion may be omitted in accordance with recording conditions, such as the types of ink and recording medium, and the recording speed.

Any medium may be used as the recording medium 1100. For example, such recording media each having ink absorbency (permeability) as described below may each be used as the recording medium 1100: a recording medium free of a coating layer, such as plain paper, uncoated paper or synthetic paper; and a recording medium including a coating layer, such as printing paper, glossy paper or art paper. In addition, a recording medium that does not have permeability like a film or sheet composed of a resin material, such as polyvinyl chloride (PVC) or polyethylene terephthalate (PET), may be used. The basis weight (g/m²) of the recording medium 1100 is preferably 30 g/m² or more to 500 g/m² or less, more preferably 50 g/m² or more to 450 g/m² or less.

### Recording Portion

The recording portion 1000 includes the liquid applying device 1200. The liquid applying device 1200 includes a reaction liquid applying device 1201 and an ink applying device 1202. The reaction liquid applying device 1201 illustrated in FIG. 1 is an example of a unit including an ink jet discharge head. The reaction liquid applying device may also be constituted by utilizing a gravure coater, an offset coater, a die coater, a blade coater or the like. The reaction liquid may be applied by the reaction liquid applying device 1201 before or after the application of the ink as long as the liquid can be brought into contact with the ink on the recording medium 1100. However, to record high-quality images on various recording media having different liquid-absorbing characteristics, the reaction liquid can be applied before the application of the ink. An ink jet discharge head (recording head) is used as the ink applying device 1202. Examples of the discharge system of the discharge head serving as the liquid applying device 1200 include a system including causing film boiling in a liquid with an electrothermal converter to form an air bubble, to thereby discharge the liquid; and a system including discharging the liquid with an electromechanical transducer. In the recording method and recording apparatus according to an embodiment of the present disclosure, for example, the liquid applying device 1200 (ink applying device 1202) can be used to discharge the ink from the discharge port of the liquid applying device to record an image on the recording medium.

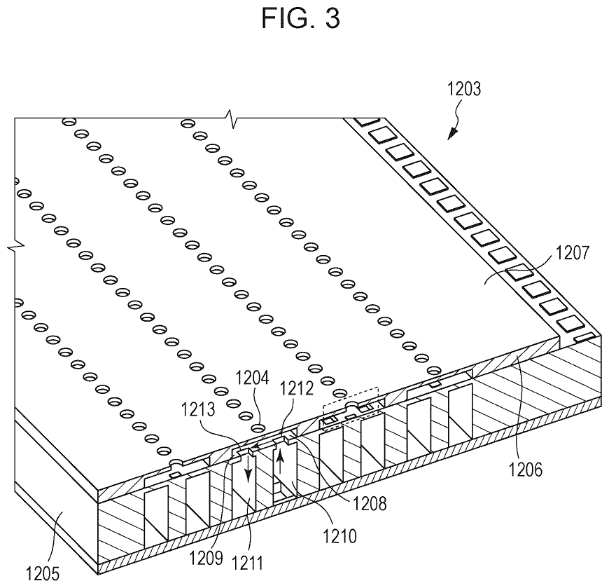

The liquid applying device 1200 is a line head arranged in the Y-direction in an extended manner, and its discharge ports are arrayed in a range covering the image recording region of the recording medium having the maximum usable width. The discharge head has a discharge port surface 1207 (FIG. 3) including a discharge port on its lower side, which is adjacent to the recording medium 1100. The discharge port surface faces the recording medium 1100 with a minute distance of about several millimeters therebetween.

Multiple ink applying devices 1202 may be arranged for applying inks of respective colors to the recording medium 1100. For example, when respective color images are recorded with a yellow ink, a magenta ink, a cyan ink and a black ink, the four ink applying devices 1202 that discharge the above-mentioned four types of inks are arranged side by side in the X-direction. The ink and the reaction liquid are hereinafter sometimes collectively referred to as “liquids”.

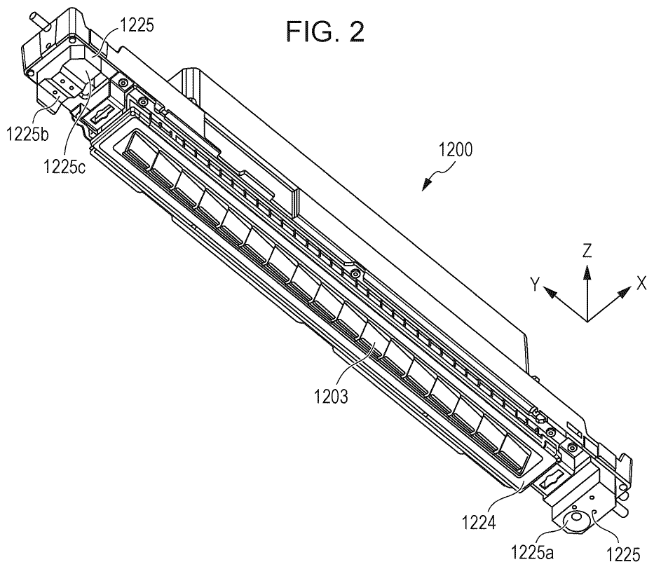

FIG. 2 is a perspective view illustrating an example of the liquid applying device. The liquid applying device 1200 illustrated in FIG. 2 is a line head. The line head includes multiple discharge element substrates 1203 that have discharge port arrays and that are linearly arranged. In each of the discharge element substrates 1203, the multiple discharge port arrays are arranged. A protective member (hereinafter, also referred to as a “first protective member”) 1224 for protecting the multiple discharge element substrates 1203 is disposed on the circumferential portion of the discharge element substrates 1203 linearly arranged. The liquid applying device 1200 includes a first positioning portion 1225 on each end thereof. The first positioning portions 1225 are used for positioning capping units, which will be described below. Specifically, a first contact portion 1225a, which is a recessed portion having a conical slope, is provided on the near side of the figure in the longitudinal direction (Y-direction) of the liquid applying device 1200. A second contact portion 1225b, which is a V-shaped groove portion having two flat surfaces, and a third contact portion 1225c, which is a flat surface portion, are respectively provided on the far side of the figure in the longitudinal direction (Y-direction) of the liquid applying device 1200.

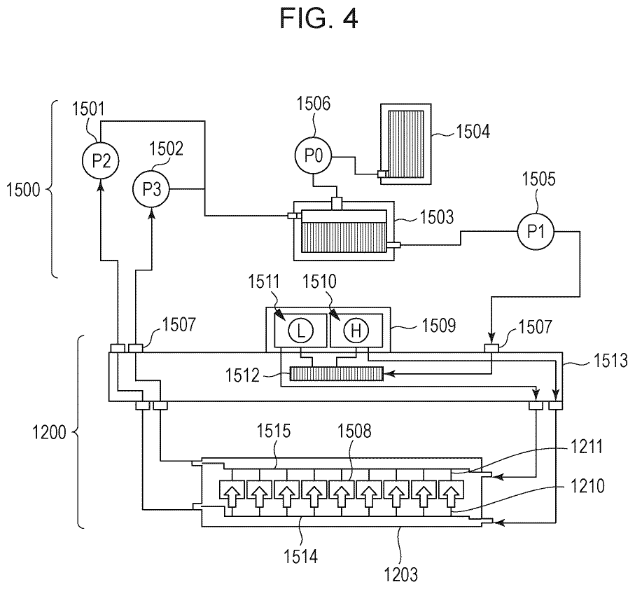

FIG. 3 is a sectional perspective view illustrating an example of each of the discharge element substrates. The discharge element substrate 1203 illustrated in FIG. 3 includes a discharge port forming member 1206 having a discharge port 1204 opened, and a substrate 1205 having a discharge element (not illustrated) arranged thereon. The lamination of the discharge port forming member 1206 and the substrate 1205 forms a first flow path 1208 and a second flow path 1209 through which a liquid flows. The first flow path 1208 is a region from an inflow port 1212, into which the liquid flows from an inflow path 1210, to a portion between each of the discharge ports 1204 and a corresponding one of the discharge elements (FIG. 4, a liquid chamber 1508). The second flow path 1209 is a region from the portion between the discharge port 1204 and the discharge element (FIG. 4, the liquid chamber 1508) to an outflow port 1213 from which the liquid flows out to an outflow path 1211. For example, if a pressure difference is provided between the inflow port 1212 and the outflow port 1213, such as the inflow port 1212 having a high pressure and the outflow port 1213 having a low pressure, the liquid can be allowed to flow from the higher-pressure side to the lower-pressure side (in the direction of the arrow in FIG. 3). The liquid passed through the inflow path 1210 and the inflow port 1212 enters the first flow path 1208. The liquid passed through the portion between the discharge port 1204 and the discharge element (FIG. 4, the liquid chamber 1508) flows to the outflow path 1211 through the second flow path 1209 and the outflow port 1213.

### Supply System

FIG. 4 is a schematic view illustrating an example of a supply system for a liquid such as an ink. A supply portion 1500 of the liquid applying device 1200 illustrated in FIG. 4 includes a first circulation pump (high-pressure side) 1501, a first circulation pump (low-pressure side) 1502, a sub tank 1503, and a second circulation pump 1505. The sub tank 1503 connected to a main tank 1504 serving as a liquid storage portion has an air communication port (not illustrated) and hence can discharge air bubbles mixed into a liquid to the outside of a circulation system. The sub tank 1503 is also connected to a replenishment pump 1506. A liquid is consumed in the liquid applying device 1200 by the discharge (ejection) of the liquid from a discharge port in, for example, image recording or suction recovery. The replenishment pump 1506 transfers the liquid from the main tank 1504 to the sub tank 1503 in an amount corresponding to the amount consumed.

The first circulation pump (high-pressure side) 1501 and the first circulation pump (low-pressure side) 1502 allows the liquid in the liquid applying device 1200, which has been caused to flow out from a connection portion (inflow portion) 1507, to flow to the sub tank 1503. A positive-displacement pump having a quantitative liquid-delivering ability can be used as each of the first circulation pump (high-pressure side) 1501, the first circulation pump (low-pressure side) 1502 and the second circulation pump 1505. Examples of such positive-displacement pump include a tube pump, a gear pump, a diaphragm pump and a syringe pump. At the time of the driving of each of the discharge element substrates 1203, the liquid can be allowed to flow from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515, respectively, in the discharge element substrate 1203 through a supply unit 1513 having arranged therein a filter 1512 that removes foreign matter from a liquid. The discharge element substrate 1203 includes the common inflow path 1514, the common outflow path 1515, and the inflow path 1210 and the outflow path 1211 that communicate with the liquid chamber 1508 serving as the portion between the discharge port 1204 and the discharge element (not illustrated). The inflow path 1210 and the outflow path 1211 communicate with the common inflow path 1514 and the common outflow path 1515, respectively. Accordingly, a flow (arrow in FIG. 4) occurs in which part of the liquid passes the inside of the liquid chamber 1508 from the common inflow path 1514 to flow to the common outflow path 1515. The arrows in FIG. 3 indicate the flow of the liquid in the liquid chamber 1508. That is, as illustrated in FIG. 3, the liquid in the first flow path 1208 flows to the second flow path 1209 through a portion between the discharge port 1204 and the discharge element.

As illustrated in FIG. 4, the pressure adjusting mechanism (high-pressure side) 1510 is connected to the common inflow path 1514, and the pressure adjusting mechanism (low-pressure side) 1511 is connected to the common outflow path 1515. Accordingly, a pressure difference is provided between the inflow path 1210 and the outflow path 1211. Thus, a pressure difference is also provided between the inflow port 1212 (FIG. 3) communicating with the inflow path 1210 and the outflow port 1213 (FIG. 3) communicating with the outflow path 1211. When a liquid is allowed to flow by the pressure difference between the inflow port 1212 and the outflow port 1213, the flow rate (mm/s) of the liquid can be controlled to 0.1 mm/s or more to 10.0 mm/s or less.

### Conveyance System

As illustrated in FIG. 1, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective liquid applying devices 1200 receive the image signal of recording data to apply the required reaction liquid and ink to the respective positions. Although the conveying member 1300 in the form of a conveying belt is illustrated in FIG. 1, for example, a spur or a conveying cylinder may be used as long as the spur or the conveying cylinder has a function of conveying the recording medium 1100. To improve conveyance accuracy, a member that can fix the recording medium 1100 can be used as the conveying member 1300. Specific examples thereof include a technique including arranging holes in the conveying member 1300 and suctioning the recording medium 1100 from its rear surface side to fix the recording medium; and a technique including forming the conveying member 1300 from an appropriate material and electrostatically adsorbing the recording medium 1100 to fix the recording medium.

### Maintenance System

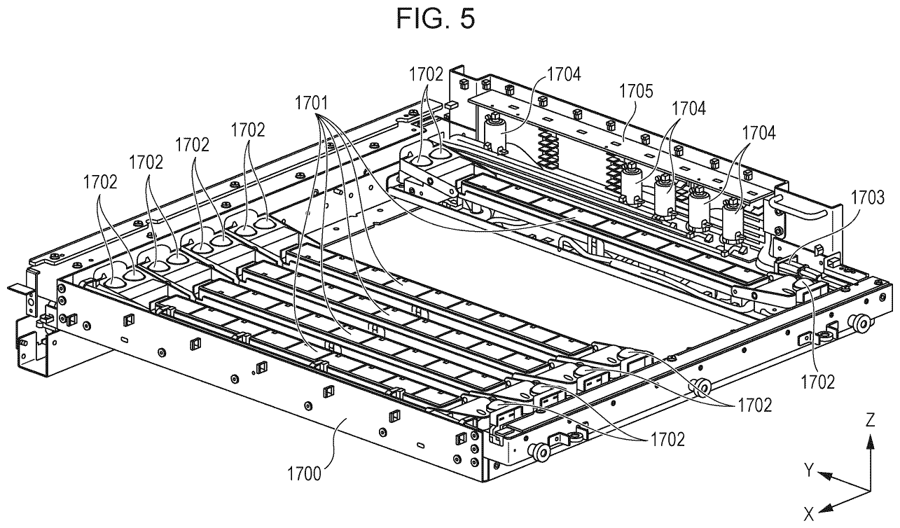

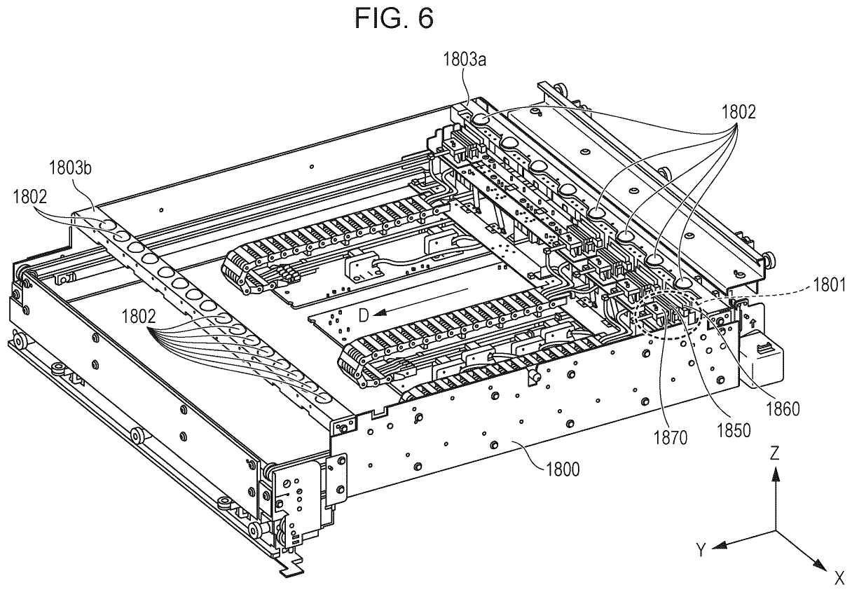

As illustrated in FIG. 1, the recording portion 1000 includes the maintenance device 1600. The maintenance device 1600 performs maintenance to recover the liquid discharge performance of the liquid applying device 1200. The maintenance device 1600 includes, for example, a capping unit 1701 (see FIG. 5) that protects the discharge port surface 1207 (see FIG. 3), and a cleaning unit 1801 (see FIG. 6) that cleans the discharge port surface 1207 (see FIG. 3). The maintenance device 1600 further includes a driving device and a rail, which are not illustrated, and is configured to be movable in the X-direction in FIG. 1 along the rail. When the maintenance of the liquid applying device 1200 is performed, the maintenance device 1600 is moved to a position immediately below the liquid applying device 1200. When the maintenance of the liquid applying device 1200 is not performed, the maintenance device 1600 is moved to a position away from immediately below the liquid applying device 1200.

The configuration of the maintenance device 1600 will be described below. The maintenance device 1600 illustrated in FIG. 1 includes a capping tray 1700 having the capping unit 1701 (see FIG. 5) and a cleaning tray 1800 having the cleaning unit 1801 (see FIG. 6). The capping tray 1700 and the cleaning tray 1800 are configured to be movable in the longitudinal direction of the ink jet recording apparatus, which is in the X-direction in FIG. 1, by a driving motor and a rail, which are not illustrated, provided on the housing of the ink jet recording apparatus 100.

FIG. 5 is a perspective view illustrating an example of the capping tray 1700. The capping tray 1700 includes a plurality of capping units 1701 for protecting the discharge port surfaces of the reaction liquid applying device 1201 and the ink applying device 1202, which are included in the liquid applying device 1200. The capping units 1701 include a plurality of spherical second positioning portions 1702 used to position the capping units 1701 relative to the liquid applying devices 1200. One second positioning portion 1702 is disposed at one end portion of one capping unit 1701 in the longitudinal direction, and two second positioning portions 1702 are disposed at the other end portion. The positions of the liquid applying device 1200 and the capping unit 1701 are regulated by abutment between the first positioning portions 1225 (see FIG. 2) provided on both ends of the liquid applying device 1200 and the second positioning portions 1702 of the capping unit 1701. The capping unit 1701 can protect the discharge port surface 1207 (see FIG. 3) of the liquid applying device 1200 by covering the discharge port surface side when the liquid applying device 1200 is not in use, and can perform suction by the negative pressure applying device described below.

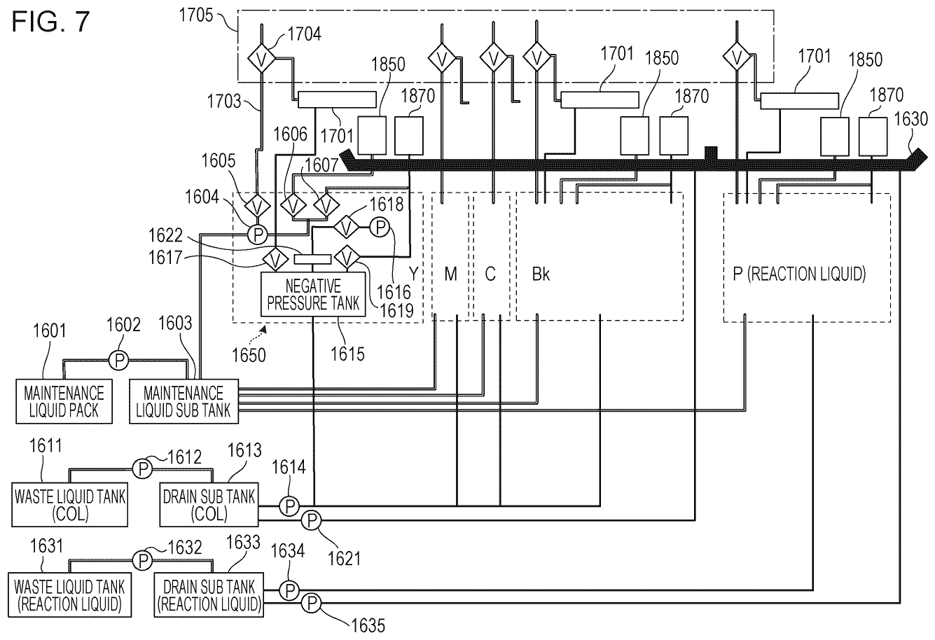

A capping liquid supply flow path 1703 illustrated in FIG. 5 is a flow path through which the maintenance liquid is supplied to the capping unit 1701. As illustrated in FIG. 5, the capping liquid supply flow path 1703 of the capping unit 1701 corresponding to each liquid applying device 1200 includes a plurality of cap upstream three-way valves 1704, and has a three-way valve upstream flow path and a three-way valve downstream flow path. The upstream side of each cap upstream three-way valve 1704 (maintenance liquid sub tank 1603 (see FIG. 7) side) is defined as the three-way valve upstream flow path, and the downstream side is defined as the three-way valve downstream flow path. The multiple cap upstream three-way valves 1704 are supported by a three-way valve support member 1705 by a fixing method, which is not illustrated.

FIG. 6 is a perspective view illustrating an example of the cleaning tray 1800. The cleaning tray 1800 has a plurality of cleaning units 1801 for cleaning each discharge port surface 1207. The cleaning tray 1800 includes a plurality of spherical third positioning portions 1802 used to position the cleaning units 1801 relative to the liquid applying device 1200. The third positioning portions 1802 are disposed on beam members 1803a and 1803b that are disposed inside the cleaning tray 1800 and that are disposed on both sides in the width direction (Y-direction in FIG. 1) of the recording medium 1100 to be conveyed. To position one liquid applying device 1200 relative to the cleaning tray 1800, three third positioning portions 1802 are required. Specifically, one third positioning portion 1802 is disposed on the beam member 1803a on the near side of the figure in the Y-direction in FIG. 1 within the cleaning tray 1800. Two third positioning portions 1802 are disposed on the beam member 1803b on the far side of the figure.

The positions of the liquid applying device 1200 and the cleaning tray 1800 are regulated by abutment between the first positioning portions 1225 provided on both end portions of the liquid applying device 1200 and the third positioning portions 1802 of the cleaning tray 1800.

The configuration for positioning the first positioning portion 1225 with respect to the second positioning portion 1702 and/or the third positioning portion 1802 is not limited to the configuration using the spherical positioning portions. For example, the positioning configuration may be a configuration in which a part of the liquid applying device 1200 is abutted on the capping unit 1701 or the cleaning tray 1800. In addition, for example, the liquid applying device 1200 and holes provided in the capping unit 1701 and the cleaning tray 1800 may be positioned using pins.

Each cleaning unit 1801 includes a maintenance liquid applying device 1850, a liquid removing device 1860, and a negative pressure applying device 1870. The maintenance liquid applying device 1850 is a device that applies a maintenance liquid to the discharge port surface 1207 of the liquid applying device 1200. The liquid removing device 1860 is a device for removing the maintenance liquid from the discharge port surface 1207 of the liquid applying device 1200, and is a device that can remove the liquid, paper dust, maintenance liquid, and the like that are attached to the liquid applying device 1200. The negative pressure applying device 1870 is a device for applying a negative pressure to the discharge port surface 1207 of the liquid applying device 1200 to perform suction, thereby removing the ink solidified in the vicinity of the discharge port and removing bubbles in the first flow path 1208 and the second flow path 1209. As illustrated in FIG. 6, the cleaning unit 1801 is configured to be movable along a wiping direction (direction D in FIG. 6) perpendicular to the conveying direction of the recording medium 1100. The cleaning unit 1801 removes the liquid, paper dust, maintenance liquid and so forth from the discharge port surface 1207 of the liquid applying device 1200 with the maintenance liquid applying device 1850, the liquid removing device 1860 and the negative pressure applying device 1870.

### Supply System of Maintenance Device

The supply system of the maintenance device 1600, such as a maintenance liquid supply path, a suction flow path and a waste liquid flow path, will be described with reference to FIG. 7. The maintenance liquid is sent from a maintenance liquid pack 1601 to the maintenance liquid sub tank 1603 by a pump 1602. The maintenance liquid can be supplied from the maintenance liquid sub tank 1603 to the capping unit 1701, the maintenance liquid applying device 1850 and the negative pressure applying device 1870 by a maintenance liquid supply pump 1604. The maintenance liquid supply pump 1604 is provided in a maintenance liquid and negative pressure supply unit 1650 (Y: yellow, M: magenta, C: cyan, Bk: black, P: reaction liquid) corresponding to the liquid applying device 1200. The timing of supplying the maintenance liquid to the capping unit 1701, the maintenance liquid applying device 1850 and the negative pressure applying device 1870 can be controlled by opening/closing valves 1605, 1606 and 1607.

A negative pressure is applied to the capping unit 1701 and the negative pressure applying device 1870 by a suction pump 1616 connected to a negative pressure tank 1615. A negative pressure can be applied to each capping unit 1701 and each negative pressure applying device 1870 via each negative pressure tank 1615 and the opening/closing valves 1617, 1618 and 1619. When a liquid is suctioned using the capping unit 1701 and the negative pressure applying device 1870, a waste liquid suctioned from the liquid applying device 1200 is collected in the drain sub tank 1613 from the negative pressure tank 1615 by the pump 1614. The waste liquid is then pumped from a drain sub tank 1613 to a waste liquid tank 1611 by a pump 1612. The supply system includes a recovery tray 1630 for recovering the maintenance liquid overflowing from the maintenance liquid applying device 1850. The excess maintenance liquid is sent to a drain sub tank 1613 by a pump 1621. The amount of waste liquid in the waste liquid tank 1611 is detected by a waste liquid tank detection sensor (not illustrated). When the amount of waste liquid approaches the upper limit of the capacity of the waste liquid tank 1611, the user is prompted to replace the waste liquid tank 1611.

The waste liquid from the reaction liquid applying device 1201 is stored in a drain sub tank 1633 for the reaction liquid by a pump 1634 separately from the waste liquid flow path from the ink applying device 1202, and is then stored in a waste liquid tank 1631 for the reaction liquid by a pump 1632. This prevents the reaction liquid and the ink from mixing in the waste liquid flow path, making it possible to inhibit blockage of the flow path due to ink solidification in the flow path.

As in the supply system described above, the maintenance liquid and negative pressure supply unit 1650 corresponding to each liquid applying device is provided with the maintenance liquid supply pump 1604 and the opening/closing valves 1605, 1606 and 1607 for controlling the supply of maintenance liquid to each flow path. The maintenance liquid and negative pressure supply unit 1650 is also provided with the negative pressure tank 1615, the suction pump 1616 for suction and the opening/closing valves 1617, 1618 and 1619 for controlling the application of a negative pressure to each section. The maintenance liquid and negative pressure supply unit 1650 may be provided with a filter 1622.

### Operation of Maintenance Device to Inhibit Blockage of Flow Path

The operation of the maintenance device for inhibiting blockage of the flow path will be described with reference to FIG. 7. When a liquid is suctioned from the liquid applying device 1200 using the capping unit 1701, the liquid is inhibited from solidifying in the capping unit 1701 and in the supply system connected to the waste liquid tanks 1611 and 1631, thereby inhibiting blockage of the flow path. For this purpose, after the liquid is suctioned, the liquid applying device 1200 is moved away from the capping unit 1701, and then an open suction action is performed. Thereby, the liquid inside the capping unit 1701 and in the flow paths is sent to the waste liquid tanks 1611 and 1631. Then the cap upstream three-way valve 1704 is opened, and the capping unit 1701 is filled with the maintenance liquid through the valve. Similarly, the open suction action is then performed to send the maintenance liquid to the waste liquid tanks 1611 and 1631 to wash the inside of the capping unit 1701 and the inside of the flow paths, thereby making it possible to inhibit blockage of the supply system. To inhibit blockage of a high level, the washing step using the maintenance liquid can be performed multiple times, specifically about three to five times.

A liquid can be subjected to preliminary discharge from the liquid applying device 1200 to the capping unit 1701. The preliminary discharge is an operation performed to stabilize the discharge state when replacing the liquid applying device 1200 or during the maintenance operation of the liquid applying device, or to normalize the discharge state at any timing, such as before the start of recording, during the recording operation, or after the end of recording. When preliminary discharge is performed with the maintenance device, the cap upstream three-way valve 1704 is opened to fill the capping unit 1701 with the maintenance liquid. Then a predetermined amount of liquid is subjected to preliminary discharge from the liquid applying device 1200 into the capping unit 1701. Thereafter, an open suction action is performed to send the liquid inside the capping unit 1701 and the flow paths together with the maintenance liquid to the waste liquid tanks 1611 and 1631. If necessary, as described above, the cap upstream three-way valve 1704 may be opened to fill the maintenance liquid into the capping unit 1701, and then a flow path washing step may be performed in which an open suction action is similarly performed to send the maintenance liquid to the waste liquid tanks 1611 and 1631.

### Operation to Leave Liquid Applying Device Capped

An operation to leave the liquid applying device capped will be described with reference to FIGS. 5 and 7. In the case where the recording operation is completed and where recording is not performed for a certain period of time, the discharge port surface of the liquid applying device 1200 can be capped to inhibit the evaporation of the liquid in order to inhibit the liquid from solidifying in the flow path. Capping can be performed by bringing the liquid applying device 1200 into contact with the capping unit 1701 illustrated in FIG. 5. Before the capping unit 1701 is brought into contact, the cap upstream three-way valve 1704 illustrated in FIG. 7 is opened to fill the maintenance liquid into the capping unit 1701. Thereafter, the liquid applying device 1200 is brought into contact with the capping unit 1701 and thereby capped, making it possible to effectively inhibit the solidification of the liquid in the flow path in the liquid applying device 1200. Even if the capped state continues for a certain period of time, in the case of the liquid applying device 1200 including a liquid circulation mechanism (not illustrated) in the flow path, the liquid can be stably discharged from the initial stage of the restart of recording by a liquid circulation operation in the flow path in a preparation operation for recording.

### Configuration of Cleaning Unit

FIG. 8 is an enlarged perspective view of the dashed line portion illustrated in FIG. 6, and indicates the configuration of the cleaning unit 1801 arranged in the cleaning tray 1800. The cleaning unit 1801 includes the maintenance liquid applying device 1850, the liquid removing device 1860 and the negative pressure applying device 1870. The liquid removing device 1860 includes a wiper blade 1861 composed of a flexible material such as urethane rubber. FIG. 8 illustrates an example in which two wiper blades are arranged. However, the size and number of wiper blades can be set in consideration of the structure of the discharge port surface of the liquid applying device 1200, removal performance and so forth. The negative pressure applying device 1870 includes a flexible member 1871. It is possible to select a material that can efficiently remove liquid, bubbles and so forth by applying a negative pressure when it comes into contact with the discharge port surface 1207 of the liquid applying device 1200.

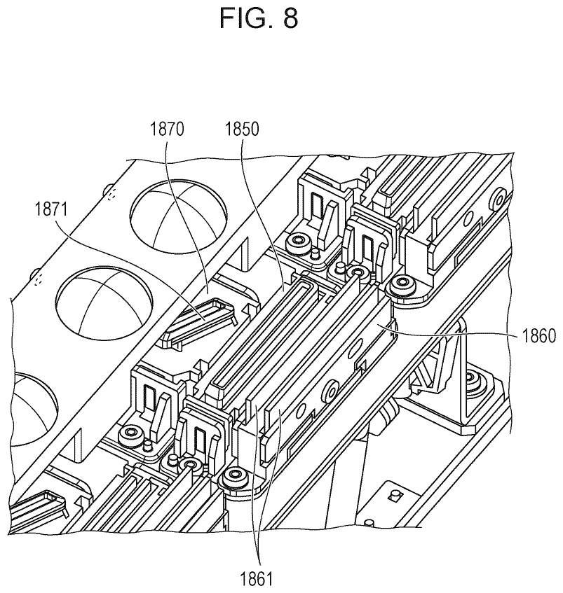

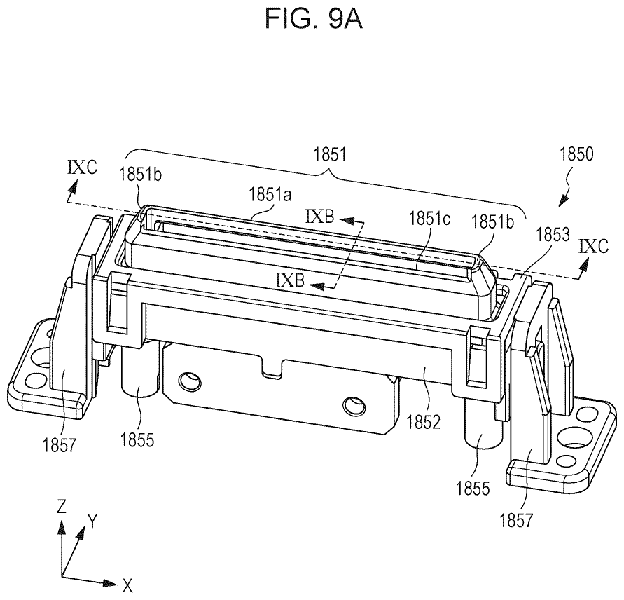

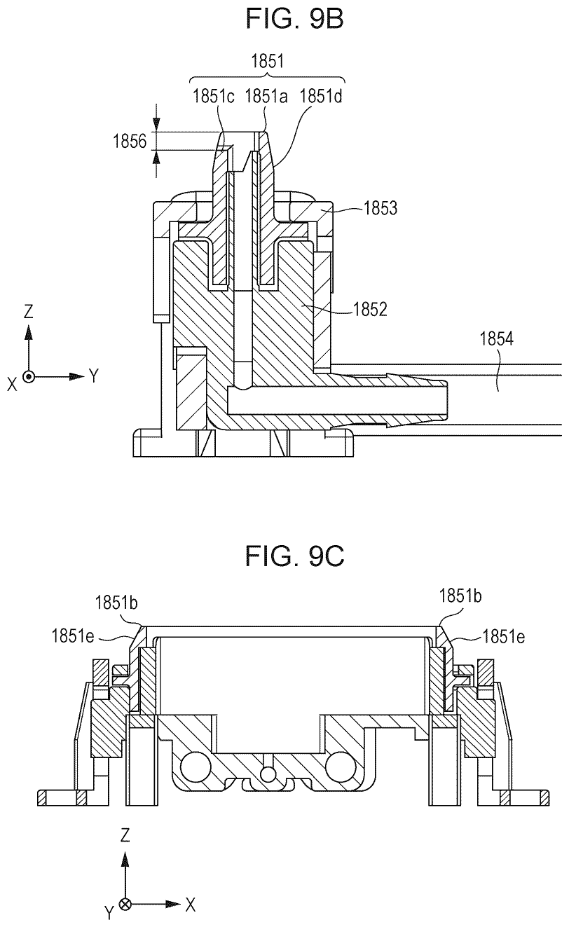

FIGS. 9A to 9C are schematic views illustrating the configuration of the maintenance liquid applying device 1850. FIG. 9A is a perspective view illustrating the maintenance liquid applying device 1850. FIG. 9B is a sectional view taken along line IXB-IXB of FIG. 9A that illustrates the maintenance liquid applying device 1850. FIG. 9C is a sectional view taken along line IXC-IXC of FIG. 9A that illustrates an example of the maintenance liquid applying device 1850. The maintenance liquid applying device 1850 includes a flexible maintenance liquid applying member 1851. The maintenance liquid applying device 1850 also includes a maintenance liquid applying member holder 1852 which holds the maintenance liquid applying member 1851 and in which a flow path for supplying the maintenance liquid to the inside of the maintenance liquid applying member 1851 is formed. In addition, the maintenance liquid applying device 1850 includes a maintenance liquid applying member cover 1853 that covers the maintenance liquid applying member 1851.

The maintenance liquid applying member 1851 is held between the maintenance liquid applying member holder 1852 and the maintenance liquid applying member cover 1853. As illustrated in FIG. 9B, a maintenance liquid supply tube 1854 is connected to the maintenance liquid applying member holder 1852. The maintenance liquid supplied from the maintenance liquid supply tube 1854 passes through the maintenance liquid applying member holder 1852, and is applied to the discharge port surface 1207 by the maintenance liquid applying member 1851. The maintenance liquid applying device 1850 also includes an urging member 1855. The maintenance liquid applying member 1851 is pressed against the discharge port surface 1207 while the maintenance liquid is applied to the discharge port surface 1207. The maintenance liquid applying device 1850 is attached to the cleaning tray 1800 by a support portion 1857.

As illustrated in FIGS. 9A to 9C, the maintenance liquid applying member 1851 has a notch in part of its surface that comes into contact with the discharge port surface 1207. The maintenance liquid applying member 1851 has a surface 1851a (first surface) on the upstream side (positive Y-direction) and a surface 1851c (third surface) on the downstream side (negative Y-direction) with respect to the application direction of the maintenance liquid, and also has a surface 1851b (second surface) that intersects with the first surface 1851a. When the maintenance liquid is applied to the discharge port surface 1207, the first surface 1851a on the upstream side in the application direction of the maintenance liquid and the second surface 1851b intersecting with the first surface 1851a come into contact with and are pressed against the discharge port surface 1207. At this time, a gap 1856 is formed between the third surface 1851c on the downstream side in the application direction of the maintenance liquid and the discharge port surface 1207. In the illustrated example, the contact length of the first surface 1851a with the discharge port surface 1207 is longer than the contact length of the second surface 1851b with the discharge port surface 1207. This results in the maintenance liquid applying member 1851 that easily conforms to the surface profile of the discharge port surface 1207.

As illustrated in FIG. 9B, the first surface 1851a, which is configured to come into contact with the discharge port surface 1207, on the upstream side in the application direction of the maintenance liquid is thinner than a base portion 1851d thereof. As illustrated in FIG. 9C, the second surface 1851b intersecting with the first surface 1851a on the upstream side in the application direction of the maintenance liquid is thinner than a base portion 1851e thereof. Due to this configuration, the tip of the maintenance liquid applying member 1851 has a thin wall thickness and is easily deformed. Thus, when the maintenance liquid applying member 1851 is pressed against the uneven discharge port surface 1207, it is possible to make the maintenance liquid applying member 1851 conform to the unevenness of the discharge port surface 1207.

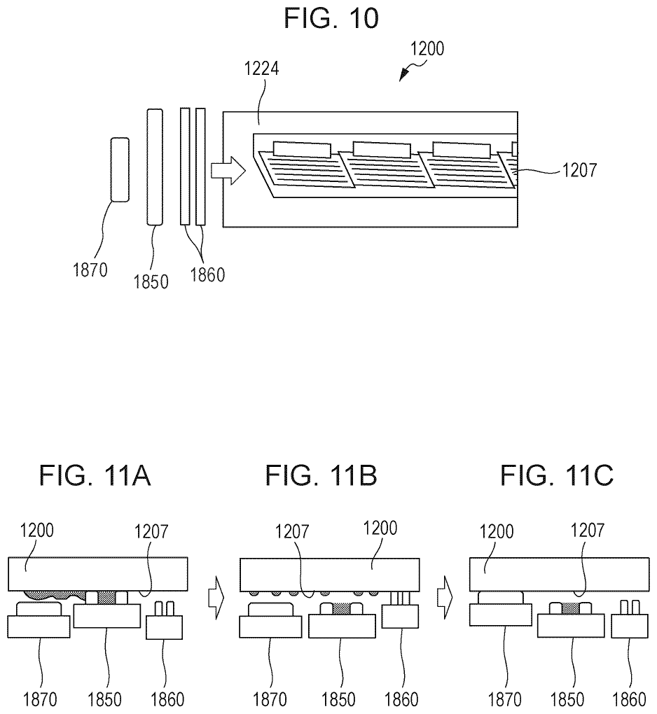

FIG. 10 is a schematic view illustrating the positional relationship between the liquid applying device and the cleaning unit. This figure illustrates a state in which the maintenance liquid applying device 1850, the liquid removing device 1860 and the negative pressure applying device 1870 are in contact with the discharge port surface 1207 of the liquid applying device 1200. The maintenance liquid applying device 1850, the liquid removing device 1860 and the negative pressure applying device 1870 are each configured to be able to come into contact with and move away from the discharge port surface 1207. Therefore, these can be swept in the longitudinal direction of the liquid applying device 1200 to apply the maintenance liquid, remove a liquid or a maintenance liquid mixture by suction, and wipe the liquid applying device 1200.

A cleaning step of cleaning the discharge port surface 1207 of the liquid applying device 1200 will be described. As an example of how cleaning can be performed efficiently, FIGS. 11A to 11C are schematic views illustrating an example of the cleaning operation of the liquid applying device 1200. An embodiment of the present disclosure is not limited to this method.

The maintenance liquid applying device 1850 is swept while being in contact with the liquid applying device 1200 to apply the maintenance liquid to the discharge port surface 1207 and a first protective member 1224 (FIG. 11A). The liquid removing device 1860 is swept while being in contact with the discharge port surface 1207 and the first protective member 1224 to wipe off a liquid and so forth adhering to the discharge port surface 1207 of the liquid applying device 1200 together with the maintenance liquid previously applied (FIG. 11B). The negative pressure applying device 1870 can be swept while being in contact with the discharge port surface 1207 of the liquid applying device 1200 to remove liquid solidified near the discharge port on the discharge port surface 1207 and to remove bubbles within the flow path (FIG. 11C). The steps in FIGS. 11A to 11C may be performed in this order, or each step may be performed in parallel.

When the liquid removing device 1860 is swept while in contact with the discharge port surface 1207 and the first protective member 1224 to wipe off the liquid and so forth adhering to the discharge port surface 1207, the sweep direction of the liquid removing device 1860 may be the positive Y-direction or the negative Y-direction in FIG. 6. Similarly, when the negative pressure applying device 1870 is swept while in contact with the discharge port surface 1207 to remove a solidified liquid present on the discharge port surface 1207, the sweep direction of the negative pressure applying device 1870 may be the positive Y-direction or the negative Y-direction in FIG. 6.

The scanning speed of the maintenance liquid applying device 1850 can be 40 mm/s or more to 120 mm/s or less. The scanning speed of the liquid removing device 1860 can be 50 mm/s or more to 150 mm/s or less. The scanning speed of the negative pressure applying device 1870 can be 1.0 mm/s or more to 15.0 mm/s or less. The negative pressure applied by the negative pressure applying device 1870 can be −20 kPa or less.

For example, when the above-mentioned configuration regarding the maintenance system is used, a recording method according to an embodiment of the present disclosure can include the following steps. That is, the method can include the steps of: discharging an aqueous ink from a discharge port of a liquid applying device to record an image on a recording medium; applying a maintenance liquid to a discharge port surface of the liquid applying device, the discharge port surface including the discharge port; and cleaning the discharge port surface of the liquid applying device. After the step of applying the maintenance liquid to the discharge port surface, the step of cleaning the discharge port surface can be performed. In the step of cleaning the discharge port surface of the liquid applying device (cleaning step), the discharge port surface can be cleaned with a wiper blade and by application a negative pressure.

A protective member (hereinafter, also referred to as a “second protective member”) for protecting the discharge port surface 1207 of the discharge element substrate 1203 can be provided. That is, the liquid applying device 1200 can include the second protective member for protecting the discharge port surface 1207. The second protective member can have an opening for a discharge port array in which multiple discharge ports 1204 are arranged in a predetermined direction. Specifically, the second protective member having rectangular openings corresponding to the discharge port array is bonded to the discharge port surface 1207 with an adhesive. With this configuration, if the recording medium 1100 floats up during conveyance, the second protective member serves to inhibit contact between the recording medium 1100 and the discharge element substrate 1203, thereby inhibiting damage to the liquid applying device 1200. Thus, the second protective member may have sufficient mechanical strength, and may be composed of, for example, a metal material, such as stainless steel or aluminum, silicone or alumina.

The second protective member has a rectangular opening for the discharge port array. The opening can be arranged for any number of discharge port arrays. A plurality of openings can be provided for one second protection member. One opening can be formed for one discharge port array.

The length of the opening of the second protective member in a direction substantially intersecting with the direction of the discharge port array can be 250 m or more to less than the interval between adjacent discharge port arrays. The thickness of the second protective member can be less than 50 m. In this case, when the maintenance device 1600 of the recording apparatus comes into contact with the liquid applying device 1200 during maintenance, the maintenance device 1600 can recover the liquid present on the discharge port surface 1207 of the liquid applying device 1200.

### Heating Portion

As illustrated in FIG. 1, the heating portion 2000 includes a heating device 2100 and a conveying member 2200. The recording medium 1100 to which the reaction liquid and the ink have been applied and on which an image has been recorded is heated by the heating device 2100 while being conveyed by the conveying member 2200, thereby evaporating the liquid component of the image to dry the image. The recording method can further include, between an ink applying step and a fixing step, a drying step of subjecting the recording medium to which the ink has been applied to non-contact heating to dry the ink. When the drying step is included, the deformation (cockling or curl) of the recording medium 1100 can be effectively inhibited.

The heating device 2100 may have any configuration as long as the device can heat the recording medium 1100. Various devices used in the art, such as a warm-air dryer and a heater, may each be used. Of these, a non-contact heater, such as a heating wire or an infrared heater, can be used in terms of safety and energy efficiency. To jet a heated gas to the recording medium 1100, the use of a mechanism for blowing a warm gas with a built-in fan easily improves the drying efficiency.

With regard to a method for the heating, the recording medium 1100 may be heated from the side of a surface (recording surface (front surface)) to which the reaction liquid and the ink have been applied, may be heated from its rear surface side or may be heated from both the surfaces. The conveying member 2200 may have a heating function. Although the conveying member 2200 using a conveying belt is illustrated in FIG. 1, for example, a spur or a conveying cylinder may be used as long as the spur or the conveying cylinder has the function of conveying the recording medium 1100. From the viewpoint of inhibiting the deformation of the recording medium 1100 by the heating, a configuration can be used in which the recording medium 1100 is conveyed while brought into close contact with the conveying member 2200 by blowing air from the heating portion 2000, or a mechanism can be arranged by which the recording medium is fixed to the conveying member 2200. Specific examples thereof include a technique including arranging holes in the conveying member 2200 and suctioning the recording medium 1100 from its rear surface side to fix the recording medium; and a technique including forming the conveying member 2200 from an appropriate material and electrostatically adsorbing the recording medium 1100 to fix the recording medium.

A heating temperature can be set in such a manner that a liquid component is quickly evaporated and that the recording medium 1100 is not overdried from the viewpoint of inhibiting the deformation of the recording medium 1100. In view of the conveying speed and the environmental temperature, the temperature of a dryer can be set in such a manner that the recording medium has a desired temperature. Specifically, the temperature of the dryer, such as a warm-air dryer, is preferably set to 40° C. or higher to 100° C. or lower, more preferably 60° C. or higher to 80° C. or lower. When a heated gas is blown to heat the recording medium 1100, a gas velocity can be set to 1 m/s or more to 100 m/s or less. The temperature of wind, such as warm air, can be measured using a K-type thermocouple thermometer. A specific example of a measuring machine is a machine available under the trade name “AD-5605H” (manufactured by A&D Company, Limited).

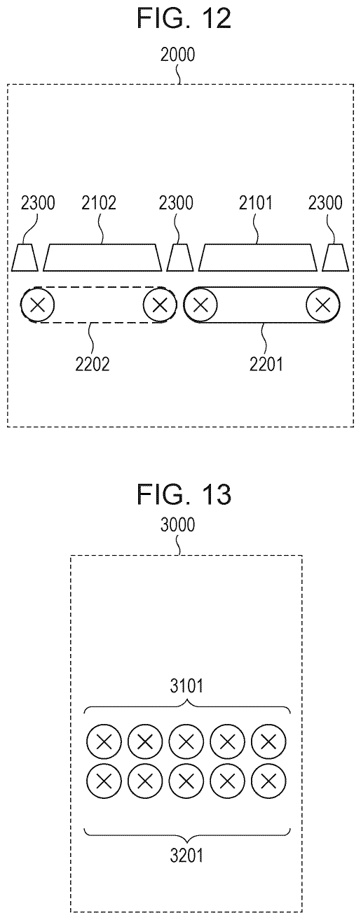

FIG. 12 is a schematic view illustrating another example of the heating portion. Here, the differences from the heating portion illustrated in FIG. 1 and described above will be described. The heating portion 2000 illustrated in FIG. 12 includes a first heating device 2101, a second heating device 2102, a first conveying member 2201 and a second conveying member 2202, the first conveying member 2201 facing the first heating device 2101, and the second conveying member 2202 facing the second heating device 2102.

The first conveying member 2201 is not provided with a mechanism for fixing the recording medium 1100 by suction. The recording medium 1100 is conveyed while pressed against the first conveying member 2201 by warm air from the first heating device 2101. Thus, the recording medium 1100 can be delivered from the conveying member 1300 (FIG. 1) to the first conveying member 2201 and from the first conveying member 2201 to the second conveying member 2202 with high accuracy. In addition, a conveyance shift due to a slight difference in conveying speed between the conveying member 1300 (FIG. 1) and the first conveying member 2201 can be reduced. Meanwhile, a conveying belt having holes that can pass a gas therethrough is used for the second conveying member 2202, and the recording medium 1100 is conveyed while fixed to the second conveying member 2202 with a suction mechanism (not illustrated).

Air knives 2300 are arranged between the conveying member 1300 (FIG. 1) and the first conveying member 2201, between the first conveying member 2201 and the second conveying member 2202 and between the second conveying member 2202 and a conveying member 3200 (FIG. 1). The lifting of the leading end portion of the recording medium 1100 conveyed is pressed down with a wind pressure from the air knives 2300. Thus, the collision of the leading end portion of the recording medium 1100 with the first heating device 2101, the second heating device 2102 and the fixing member 3100 (FIG. 1) can be avoided to inhibit the occurrence of a conveyance failure.

The first heating device 2101 and the second heating device 2102 may each have the same configuration as that of the above-mentioned heating device 2100. The first heating device 2101 and the second heating device 2102 may have the same or different temperatures. In the case of heating by blowing a heated gas, the gas velocity may be the same or different. Heating may be performed from the first conveying member 2201 and the second conveying member 2202, as needed.

### Fixing Portion

As illustrated in FIG. 1, the fixing portion 3000 is a contact-type heat and pressure-applying mechanism including the fixing member 3100 serving as a fixing belt, such as an endless belt, and the conveying member 3200. In the fixing portion 3000, the recording medium 1100 is conveyed by the conveying member 3200. The fixing member 3100 is brought into contact with the recording medium 1100 while pressure is applied to the recording medium 1100, to heat the liquids, such as the reaction liquid and the ink, applied to the recording medium 1100. Thereby, an image can be fixed to the recording medium 1100. After the liquid components of the reaction liquid and the ink permeate in the recording medium 1100 on which the image has been recorded, and evaporate as they pass through the heating portion 2000, the image are fixed in the fixing portion 3000, thereby resulting in the completion of the image. Heat and pressure are applied to the recording medium 1100 while the recording medium 1100 is interposed between the fixing member 3100 and the conveying member 3200, so that the image on the recording medium 1100 comes into close contact with the fixing member 3100, thereby fixing the image to the recording medium 1100. When a liquid, such as ink containing a resin particle and a coloring material, is used, the resin particle is softened and forms a film mainly by heating in the fixing portion 3000, and the coloring material can be bound to the recording medium 1100.

An example of a method for heating the fixing member 3100 is a method in which heating is performed by a heat source, such as a halogen heater, disposed in a roller that drives the fixing member 3100 serving as a fixing belt. A further example thereof is a method in which heating is performed by a heat source, such as an infrared heater, at a location separate from the fixing member 3100. These methods may be combined with each other. The conveying member 3200 may be heated, as needed. In consideration of the conveying speed and the environmental temperature, the temperature of the fixing member 3100 can be set in such a manner that the surface of the recording medium has a desired temperature. Specifically, the temperature of the fixing member 3100 is preferably 50° C. or higher to 120° C. or lower, more preferably 60° C. or higher to 110° C. or lower. The temperature of the contact-type heat and pressure-applying mechanism (fixing member 3100) and the surface temperature of the recording medium immediately after passing through the contact-type heat and pressure-applying mechanism can both be measured using a radiation thermometer. The radiation thermometer is only required to be disposed near an end portion (terminal) of the contact-type heat and pressure-applying mechanism. A specific example of the radiation thermometer is a thermometer available under the trade name “Radiation Thermometer IT-545S” (manufactured by Horiba, Ltd.).

When the ink contains a resin particle, a temperature of the fixing member 3100 higher than or equal to the glass transition temperature of the resin particle in the ink can result in softening of the resin particle to easily form a film, thereby improving the abrasion resistance of the image. When the ink contains a wax particle, the temperature of the fixing member 3100 can be lower than the melting point of the wax constituting the wax particle. This enables the wax that is inhibited from melting easily to remain on the surface of the image more easily, thereby improving the abrasion resistance of the image.

A nip pressure between the fixing member 3100 and the conveying member 3200, that is, a pressure applied to the recording medium when the medium passes through the contact-type heat and pressure-applying mechanism is preferably 10 Pa or more to 1,000 Pa or less, more preferably 10 Pa or more to 500 Pa or less. The pressure is particularly preferably 10 Pa or more to 400 Pa or less. The time period (nip time) required for the recording medium to pass through the contact-type heat and pressure-applying mechanism is preferably 0.25 seconds or more to 5.0 seconds or less, more preferably 0.5 seconds or more to 4.0 seconds or less, and particularly preferably 1.0 second or more to 3.0 seconds or less.

FIG. 13 is a schematic view illustrating another example of the fixing portion. Here, the differences from the fixing portion illustrated in FIG. 1 and described above will be described. The fixing portion 3000 illustrated in FIG. 13 is a contact-type heat and pressure-applying mechanism including a plurality of fixing rollers 3101 and a plurality of conveying members 3201 facing these fixing rollers 3101. The recording medium 1100 to which a liquid such as ink has been applied passes between the fixing rollers 3101 and the conveying members 3201, thereby fixing an image to the recording medium. It is possible to adjust the extent to which the image is fixed to the recording medium by controlling the number of fixing rollers 3101, the number of conveying members 3201, the nip time of the recording medium, the temperature, the pressure and so forth.

### Cooling Portion

The cooling portion 4000 includes the cooling member 4100 and a conveying member 4200 (FIG. 1). The cooling portion 4000 cools the recording medium 1100 that has passed through the heating portion 2000 and the fixing portion 3000 to have a high temperature. The cooling member 4100 may have any configuration as long as it can cool the recording medium 1100, and methods such as air cooling and water cooling can be used. In particular, blowing an unheated gas can be performed from the viewpoint of safety and energy efficiency. To jet a gas to the recording medium 1100, the use of a mechanism for blowing a gas with a built-in fan easily improves the cooling efficiency. In view of the conveying speed and the environmental temperature, the temperature of a cooling unit can be set in such a manner that the recording medium has a desired temperature. Specifically, the temperature of the cooling unit, such as an air blower, is preferably 20° C. or higher to 60° C. or lower, more preferably 25° C. or higher to 50° C. or lower. When cooling is performed by blowing a gas, the gas velocity can be 1 m/s or more to 100 m/s or less. The use of the conditions can inhibit the deformation of the recording medium 1100 to be stacked in the sheet delivery portion 6000 described below and the image sticking (blocking).

### Reversing Portion

When double-sided recording is performed, the recording medium 1100 is reversed by the use of the reversing portion 5000 (FIG. 1). The recording medium 1100 having an image recorded on its recording surface (front surface) passes through the cooling portion 4000, is then conveyed to a branch line, and reversed by the reversing device 5100. The recording medium 1100 that has been reversed is conveyed to the sheet feeding device 1400 of the recording portion 1000 in such a manner that the liquids can be applied to its rear surface, which is a surface opposite to the recording surface (front surface).

### Sheet Delivery Portion

The recording medium 1100 after the image recording is stored in the sheet delivery portion 6000 (FIG. 1). The recording medium 1100 is subjected to single-sided recording or double-sided recording, and then passes through the cooling portion 4000, is conveyed by the conveying member 6100 and finally stored in a stacked state in the recording medium storage portion 6200. Two or more recording medium storage portions 6200 may be arranged for, for example, separately storing different recorded articles.

### Maintenance Liquid

The maintenance liquid, according to an embodiment of the present disclosure, that can be used in the above-mentioned ink set, recording method and recording apparatus will be described in detail below. This maintenance liquid is used in the ink jet recording method using the ink set described above. The maintenance liquid contains an aminosulfonic acid, which is a compound having a sulfo group and an amino group in its molecule.

### Aminosulfonic Acid

The maintenance liquid contains an aminosulfonic acid. The aminosulfonic acid is a compound that has a sulfo group (—SO₃H) and an amino group (—NH₂) in its molecule. Examples of the aminosulfonic acid include aminomethanesulfonic acid, 2-aminoethanesulfonic acid (also known as taurine), 3-amino-1-propanesulfonic acid, 2-aminobenzenesulfonic acid and 3-aminobenzenesulfonic acid. These may be contained in the maintenance liquid singly or in combination of two or more.

Among the aminosulfonic acids, aminosulfonic acids having a pKa1 of 2.0 or less can be used. When the maintenance liquid contains an aminosulfonic acid having a pKa1 of 2.0 or less, the dispersibility of the sticking matter in the maintenance liquid can be increased to increase the removability of the sticking matter from the discharge port surface. Among the specific examples of the aminosulfonic acids described above, examples of the aminosulfonic acid having a pKa1 of 2.0 or less include 3-amino-1-propanesulfonic acid (pKa1=1.1) and 2-aminoethanesulfonic acid (pKa1=1.5). The term “pKa” indicates the ease of dissociation of a proton from an acid, and is the negative common logarithm (pKa=−log₁₀ Ka) of the acid dissociation constant (Ka). The amount of acid that dissociates in the maintenance liquid depends mainly on the pKa of the first-stage dissociation reaction in which a hydrogen ion is released from the acid. Thus, in the case of a compound having multiple pKa values, the pKa of an aminosulfonic acid refers to the pKa (pKa1) of the first-stage dissociation reaction in which a hydrogen ion is released from the acid.

As the aminosulfonic acid, in particular, 2-aminoethanesulfonic acid (taurine) can be used. Here, 2-aminoethanesulfonic acid has a structure in which an amino group is connected to a sulfo group with two carbon atoms (ethylene groups) provided therebetween. In this case, there is an appropriate distance between the amino group that acts on the sticking matter and the sulfo group that imparts dispersibility thereto; thus, the dispersibility of the sticking matter in the maintenance liquid can be increased to further increase the removability of the sticking matter from the discharge port surface.

The aminosulfonic acid content (% by mass) of the maintenance liquid is preferably 0.1% by mass or more to 1.0% by mass or less, more preferably 0.1% by mass or more to 0.7% by mass or less, based on the total mass of the maintenance liquid. When the aminosulfonic acid content of the maintenance liquid is 0.1% by mass or more, the amount of aminosulfonic acid that acts on the sticking matter is easily ensured, thereby easily improving the removability of the sticking matter from the discharge port surface. When the aminosulfonic acid content of the maintenance liquid is 1.0% by mass or less, the aminosulfonic acid is less likely to precipitate when the water in the maintenance liquid remaining on the discharge port surface evaporates, thereby easily inhibiting a discharge failure due to a precipitate adhering to the discharge port surface.

### Aqueous Medium

The maintenance liquid can be an aqueous maintenance liquid that contains at least water as an aqueous medium. The maintenance liquid may contain water or an aqueous medium that is a mixed solvent of water and a water-soluble organic solvent. As the water, deionized water or ion-exchanged water can be used. The water content (% by mass) of the maintenance liquid is preferably 50.0% by mass or more to 99.0% by mass or less, more preferably 60.0% by mass or more to 97.0% by mass or less, based on the total mass of the maintenance liquid.

The maintenance liquid can contain a water-soluble organic solvent. The sticking matter swells due to the action of the water-soluble organic solvent and partially peels off from the discharge port surface. This allows the maintenance liquid to enter the gap between the discharge port surface and the sticking matter, and the maintenance liquid acts efficiently on the sticking matter. This can improve the dispersibility of the sticking matter to improve the removability of the sticking matter from the discharge port surface.

The water-soluble organic solvent content (% by mass) of the maintenance liquid is preferably 2.0% by mass or more to 10.0% by mass or less, more preferably 3.0% by mass or more to 9.0% by mass or less, based on the total mass of the maintenance liquid.

The maintenance liquid can be used not only to remove the sticking matter adhering to the discharge port surface, but also as a moisturizing liquid when the recording head is left capped, and can be used to inhibit a discharge failure when the recording head is left capped. When recording is not performed temporarily, the recording head is capped and left to stand in order to inhibit the ink from drying and forming a film due to the evaporation of water from the discharge port. At that time, the inside of the recording head is moistened by filling the inside of the cap with the maintenance liquid. This makes it possible to inhibit a discharge failure when the recording head is left capped. In this case, a water-soluble organic solvent content of the maintenance liquid of 2.0% by mass or more results in a reduction in the rate of the evaporation of water in the maintenance liquid, and the moisture retention effect in the cap is easily provided, thereby easily inhibiting the occurrence of an ink discharge failure. A water-soluble organic solvent content of the maintenance liquid of 10.0% by mass or less ensures the water content of the maintenance liquid. Thus, while the recording head is left capped, water in the maintenance liquid and water in the ink inside the discharge port facilitate maintaining a constant humidity in the cap, thereby easily inhibiting the occurrence of an ink discharge failure.

The water-soluble organic solvent contained in the maintenance liquid can have a solubility parameter value (unit: (cal/cm³)^{1/2}) of 11.0 or more to 15.0 or less, the SP value being determined by Fedors' method.

As described above, the maintenance liquid can be used to remove the sticking matter adhering to the discharge port surface and as a moisturizing liquid to inhibit a discharge failure when the recording head is left capped, and can also be used to inhibit the accumulation of sticking matter due to preliminary discharge in the cap and to inhibit adhesion in an ink flow path.

When an ink having low dispersibility in the maintenance liquid continues to be preliminarily discharged into the cap, sticking matter is deposited inside the cap as the water in the ink evaporates. This deposit may adhere to the discharge port surface of the recording head when the recording head is capped, and may adversely affect an image to be recorded. To inhibit this, a portion such as a cap absorbent into which the ink is preliminarily discharged is impregnated with the maintenance liquid, and the preliminarily discharged ink diffuses into the maintenance liquid, thereby inhibiting the accumulation of sticking matter.

When the ink is suctioned by cap suctioning, the ink flows into the cap and the waste ink flow path. Thereafter, if the inside of the flow path is left as it is, the ink will solidify because of the evaporation of water, blocking the flow path. As a result, the ink does not easily pass therethrough. To inhibit this, the flow path is washed with the maintenance liquid after the ink has been suctioned, thereby providing the effect of inhibiting the solidification of the ink in the flow path.

At an SP value of the water-soluble organic solvent in the maintenance liquid of 11.0 or more, when water in the mixture of the ink and the maintenance liquid evaporates, the film formation of the resin is easily inhibited because of the high SP value of the water-soluble organic solvent. This makes it easier to provide the effect of inhibiting the accumulation of sticking matter in the cap and the effect of inhibiting solidification in the flow path. At an SP value of the water-soluble organic solvent in the maintenance liquid of 15.0 or less, the effect of swelling sticking matter on the discharge port surface is enhanced, so that the effect of the incorporation of the maintenance liquid in the water-soluble organic solvent can be easily provided.

The SP value (6) of the water-soluble organic solvent is a value calculated by Fedors' method based on the following formula (A) [unit: (cal/cm³)^{1/2}]:

$$δ = \sqrt{\frac{Δ {E}_{vap}}{V}} \qquad ( A )$$

where in formula (A), ΔEᵥₐₚ is the molar heat of vaporization (cal/mol) of the water-soluble organic solvent, and V is the molar volume (cc/mol) of the water-soluble organic solvent at 25° C.

As the water-soluble organic solvent that can be contained in the maintenance liquid, any water-soluble organic solvent typically used for aqueous inks for ink jet recording can be used. Specific examples of the water-soluble organic solvent include the following, where the SP values determined by Fedors' method are described in parentheses with the unit (cal/cm³)^{1/2} omitted. The following water-soluble organic solvents can each be contained in the maintenance liquid alone or in combination thereof.

Specific examples thereof include glycerin (16.4), 1-hydroxy-2-pyrrolidone (16.4), 1,3-propanediol (16.1), trimethylolpropane (15.9), 1,4-butanediol (15.0), diethylene glycol (15.0), ethylene glycol (14.8), 1,3-butanediol (14.8), 2-methyl-1,3-propanediol (14.8), 1,2,6-hexanetriol (14.5), urea (14.4), ethylene urea (14.2), 1,5-pentanediol (14.2), 1-(hydroxymethyl)-2-pyrrolidone (14.2), 1,2,7-heptanetriol (13.9), methanol (13.8), triethanolamine (13.7), triethylene glycol (13.6), 1,6-hexanediol (13.5), 1-(2-hydroxyethyl)-2-pyrrolidone (13.5), propylene glycol (13.5), 3-methyl-1,5-pentanediol (13.4), 2-ethylpropane-1,3-diol (13.2), 2-methylpentane-2,4-diol (13.1), tetramethylene sulfoxide (12.9), 1-(3-hydroxypropyl)-2-pyrrolidone (12.9), tetaraethylene glycol (12.8), polyethylene glycol having a number-average molecular weight of 200 (12.8), 1,2-butanediol (12.8), 2-pyrrolidone (12.6), 1-(4-hydroxybutyl)-2-pyrrolidone (12.5), 1,2-pentanediol (12.2), 3-methylsulfolane (12.1), ethylene glycol monomethyl ether (12.0), n-propanol (11.8), 1,2-hexanediol (11.8), isopropanol (11.6), N-methyl-2-pyrrolidone (11.5), ethylene glycol monoethyl ether (11.5), 1,3-dimethyl-2-imidazolidinone (11.4), n-butanol (11.3), diethylene glycol monomethyl ether (11.2), 2-butanol (11.1), isobutanol (11.1), diethylene glycol monoethyl ether (10.9), triethylene glycol monoethyl ether (10.6), polyethylene glycol having a number-average molecular weight of 600 (10.5), diethylene glycol monobutyl ether (10.5), 3-methoxy-3-methylbutanol (10.5), triethylene glycol monobutyl ether (10.3), tetraethylene glycol monobutyl ether (10.2), polyethylene glycol having a number-average molecular weight of 1,000 (10.1), 7-butyrolactone (9.9), 3-methoxy-N,N-dimethylpropionamide (9.2), tetraethylene glycol dimethyl ether (8.5), triethylene glycol butyl methyl ether (8.4) and ethylene glycol dimethyl ether (7.6).

### Other Components

In addition to the above-mentioned components, the maintenance liquid may contain various additives, such as an antifoaming agent, a surfactant, a pH adjuster, a viscosity modifier, a rust inhibitor, a preservative, an antifungal agent, an antioxidant, and a reducing inhibitor, as needed. The surfactant is preferably at least one selected from the group consisting of a silicone surfactant and an acetylene surfactant.

### Physical Properties of Maintenance Liquid

The pH of the maintenance liquid at 25° C. is preferably 7.0 or more to 12.0 or less, more preferably 8.0 or more to 11.0 or less, and still more preferably 8.5 or more to 10.5 or less. A pH of the maintenance liquid of 7.0 or more can result in stable dispersibility of sticking matter. A pH of the maintenance liquid of 12.0 or less facilitates the inhibition of corrosion of the member and the material of the recording head that come into contact with the maintenance liquid and the elution of an organic material due to corrosion. Since the elution of the organic material is easily inhibited, it is easier to inhibit the aggregate formation due to the fact that the eluted organic material adheres to the discharge port surface and mixes with the ink.

The dynamic surface tension (mN/m) of the maintenance liquid at 25° C. and a lifetime of 10 ms can be 45 mN/m or more. When the dynamic surface tension of the maintenance liquid at a lifetime of 10 ms is 45 mN/m or more, after the maintenance liquid comes into contact with the surface of sticking matter, the maintenance liquid can remain in a certain region on the surface of the sticking matter for a while, and the anionic group and the amino group can act efficiently. This can result in higher dispersibility of the sticking matter and higher removability of the sticking matter from the discharge port surface. The dynamic surface tension of the maintenance liquid at a lifetime of 10 ms is more preferably 50 mN/m or more, and is preferably 62 mN/m or less.

The dynamic surface tension of the maintenance liquid is measured by a maximum bubble pressure method. The maximum bubble pressure method is a method in which the maximum pressure required to release a bubble formed at the tip of a probe (capillary) immersed in a target liquid for measurement is measured and in which the surface tension of the liquid is determined from the resulting maximum pressure. Specifically, the maximum pressure is measured while bubbles are continuously formed at the tip of the probe. The time from when the surface of a new air bubble is formed at the tip of the probe to when the maximum bubble pressure (the point of time when the radius of curvature of the air bubble is equal to the radius of the tip portion of the probe) is reached is referred to as a “lifetime”. That is, the maximum bubble pressure method is a method for measuring the surface tension of a liquid in a moving state. The dynamic surface tension of the maintenance liquid at 10 ms can be easily adjusted by adjusting the types and amounts of water-soluble organic solvent and surfactant.

The viscosity of the maintenance liquid at 25° C. can be 0.5 mPa·s or more to 10.0 mPa·s or less.

### Reaction Liquid

The recording method according to an embodiment of the present disclosure can include a reaction liquid applying step of applying an aqueous reaction liquid containing a reactant that reacts with the aqueous ink to a recording medium. The ink set described above may further contain an aqueous reaction liquid in addition to the aqueous ink and the maintenance liquid. Components used in the reaction liquid will be described in detail below.

### Reactant

The reaction liquid reacts with the ink when the reaction liquid comes into contact with the ink, to allow a component, such as a component having an anionic group, e.g., a resin, a surfactant or a self-dispersible pigment, in the ink to aggregate, and contains a reactant. The presence of the reactant destabilizes the state of the component having an anionic group in the ink when the ink comes into contact with the reactant on the recording medium, and can promote aggregation of the component in the ink. Examples of the reactant include cationic components, such as polyvalent metal ions and cationic resins, and organic acids. These reactants may be used alone or in combination of two or more.

Examples of polyvalent metal ions constituting polyvalent metal salts include divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. These polyvalent metal salts can each be contained in the reaction liquid alone or in combination thereof. To incorporate a polyvalent metal ion into the reaction liquid, a water-soluble polyvalent metal salt, which may be a hydrate, formed by combining a polyvalent metal ion with an anion can be used. Examples of the anion include inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄² and H₂PO₄⁻; and organic anions, such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. When a polyvalent metal ion is used as the reactant, the content (% by mass) in terms of a polyvalent metal salt in the reaction liquid can be 1.0% by mass or more to 20.0% by mass or less based on the total mass of the reaction liquid. In the present specification, when the polyvalent metal salt is a hydrate, the term “polyvalent metal salt content (% by mass)” in the reaction liquid refers to the “anhydrous polyvalent metal salt content (% by mass)” excluding water in the hydrate.

The reaction liquid containing an organic acid has a buffering capacity in the acidic region (a pH of less than 7.0, such as a pH of 2.0 or more to 5.0 or less) and thus efficiently converts the anionic group of the component present in the ink into an acid form, thereby allowing them to aggregate. Examples of the organic acid include monocarboxylic acids and salts thereof, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid; dicarboxylic acids and salts and hydrogen salts thereof, such as oxalic acid, malonic acid, succinic acid, glutaric acid, adipic acid, maleic acid, fumaric acid, itaconic acid, sebacic acid, phthalic acid, malic acid and tartaric acid; tricarboxylic acids and salts and hydrogen salts thereof, such as citric acid and trimellitic acid; and tetracarboxylic acids and salts and hydrogen salts thereof, such as pyromellitic acid. These organic acids can each be contained in the reaction liquid alone or in combination thereof. When an organic acid is used as the reactant, the organic acid content (% by mass) of the reaction liquid can be 1.0% by mass or more to 50.0% by mass or less based on the total mass of the reaction liquid.

Examples of cationic resins include resins having a primary, secondary or tertiary amine structure, and resins having a quaternary ammonium salt structure. Specific examples thereof include resins having structures of, for example, vinylamine, allylamine, vinylimidazole, vinylpyridine, dimethylaminoethyl methacrylate, ethyleneimine, guanidine, diallyldimethylammonium chloride and alkylamine-epichlorohydrin condensates. These cationic resins can each be contained in the reaction liquid alone or in combination thereof. To improve the solubility in the reaction liquid, a cationic resin may be used in combination with an acidic compound, or the cationic resin may be subjected to quaternization treatment. When a cationic resin is used as the reactant, the cationic resin content (% by mass) of the reaction liquid can be 0.1% by mass or more to 10.0% by mass or less based on the total mass of the reaction liquid.

### Aqueous Medium

The reaction liquid is an aqueous reaction liquid containing at least water as an aqueous medium. Examples of the aqueous medium for use in the reaction liquid include the same ones as the aqueous medium which can be contained in the ink, which will be described below. The aqueous medium for use in the reaction liquid may contain a water-soluble organic solvent, which will be described below and which can be contained in the ink. The water-soluble organic solvent content (% by mass) of the reaction liquid can be 1.0% by mass or more to 45.0% by mass or less based on the total mass of the reaction liquid. The water-soluble organic solvent can contain a specific water-soluble hydrocarbon compound described below. The water-soluble hydrocarbon compound content (% by mass) of the reaction liquid can be 1.0% by mass or more to 20.0% by mass or less based on the total mass of the reaction liquid. The water content (% by mass) of the reaction liquid can be 50.0% by mass or more to 95.0% by mass or less based on the total mass of the reaction liquid.

### Other Components

The reaction liquid may contain various other components as needed. Examples of the other components include the same other components that can be contained in the ink, which will be described below.

### Physical Properties of Reaction Liquid

The reaction liquid is an aqueous reaction liquid for use in the ink jet method. Thus, from the viewpoint of reliability, the physical property values of the reaction liquid can be appropriately controlled. Specifically, the surface tension of the reaction liquid at 25° C. can be 20 mN/m or more to 60 mN/m or less. The viscosity of the reaction liquid at 25° C. can be 1.0 mPa·s or more to 10.0 mPa·s or less. The pH of the reaction liquid at 25° C. is preferably 5.0 or more to 9.5 or less, more preferably 6.0 or more to 9.0 or less.

### Ink

An ink set according to an embodiment of the present disclosure includes an ink and the above-mentioned maintenance liquid. In the above-mentioned recording method, an ink set including the above-mentioned maintenance liquid and an ink is used. The ink used in this recording method is an aqueous ink for ink jet recording, the aqueous ink containing a pigment dispersed by the action of an anionic group and a resin particle dispersed by the action of an anionic group. In the recording method according to an embodiment of the present disclosure, the above-mentioned aqueous ink can be discharged from a discharge port of a liquid applying device to record an image on a recording medium. Components and so forth used for the ink will be described in detail below.

### Coloring Material

The ink contains, as a coloring material, a pigment dispersed by the action of an anionic group. The pigment content (% by mass) of the ink is preferably 0.5% by mass or more to 15.0% by mass or less, more preferably from 1.0% by mass or more to 10.0% by mass or less, based on the total mass of the ink.

Specific examples of the pigment include inorganic pigments, such as carbon black and titanium oxide; and organic pigments, such as azo, phthalocyanine, quinacridone, isoindolinone, imidazolone, diketopyrrolopyrrole and dioxazine. The pigments may be used alone or in combination of two or more.

With regard to a method for dispersing the pigment, a resin-dispersed pigment using a resin as a dispersant, or a self-dispersible pigment in which a hydrophilic group is bonded to the surface of a pigment particle can be used. A resin-bonded pigment in which a resin-containing organic group is chemically bonded to the surface of a pigment particle, and a microencapsulated pigment in which the surface of a pigment particle is coated with a resin or the like can also be used. It is also possible to use a combination of these pigments having different dispersion methods. In particular, a resin-dispersed pigment in which a resin serving as a dispersant is physically adsorbed onto the surface of a pigment particle can be used, rather than a resin-bonded pigment or a microencapsulated pigment.

As a resin dispersant for dispersing a pigment in an aqueous medium, a dispersant that can disperse a pigment in an aqueous medium by the action of an anionic group can be used. As a resin dispersant, a resin having an anionic group can be used, and a resin as described below, particularly a water-soluble resin, can be used. The pigment content (% by mass) of the ink can be 0.3 to 10.0 times the resin dispersant content (% by mass) in terms of mass ratio.

As the self-dispersible pigment, it is possible to use a pigment in which an anionic group, such as a carboxylic acid group, a sulfonic acid group or a phosphonic acid group, is bonded to the surface of a pigment particle directly or with another atomic group (—R—) interposed therebetween. The anionic group may be in an acid form or a salt form.

When the anionic group is in a salt form, the anionic group may be in a partially dissociated state or a completely dissociated state. When the anionic group is in a salt form, examples of a cation serving as a counter ion include an alkali metal cation, ammonium and organic ammonium. Specific examples of the other atomic group (—R—) include linear or branched alkylene groups having 1 to 12 carbon atoms; arylene groups, such as a phenylene group and a naphthylene group; carbonyl groups; imino groups; amide groups; sulfonyl groups; ester groups; and ether groups. It may also be a combination of these groups.

The ink may contain, as a coloring material, a dye in addition to a pigment. A dye having an anionic group can be used. Specific examples of the dye include azo, triphenylmethane, (aza)phthalocyanine, xanthene and anthrapyridone dyes. These dyes may be used alone or in combination of two or more. The coloring material can be a pigment, such as a resin-dispersed pigment or a self-dispersible pigment.

### Resin

The ink contains a resin particle dispersed by the action of an anionic group. The use of the resin particle-containing ink makes it possible to record an image having improved abrasion resistance. The ink can also contain a water-soluble resin soluble in an aqueous medium. Hereinafter, the resin particle and the water-soluble resin may be collectively referred to simply as a “resin”. The resin can be added to the ink in order to (i) stabilize the dispersion state of the pigment, that is, the resin can be added as a resin dispersant or its aid. The resin can also be added to the ink in order to (ii) improve various characteristics of the image to be recorded.

The resin content (% by mass) of the ink is preferably 0.1% by mass or more to 20.0% by mass or less, more preferably 0.5% by mass or more to 15.0% by mass or less, based on the total mass of the ink. Examples of the form of the resin include a block copolymer, a random copolymer, a graft copolymer and a combination thereof. These resins may be used alone or in combination of two or more.

### Composition of Resin

Examples of the resin include an acrylic resin, a urethane-based resin and an olefin-based resin. Among them, an acrylic resin and a urethane-based resin can be used, and an acrylic resin composed of units derived from (meth)acrylic acid or (meth)acrylate can be used.

An acrylic resin having a hydrophilic unit and a hydrophobic unit as constituent units can be used as the acrylic resin. In particular, as the water-soluble resin, a resin having a hydrophilic unit derived from (meth)acrylic acid and a hydrophobic unit derived from at least one of a monomer having an aromatic ring and a (meth)acrylic acid ester monomer can be used. The aromatic ring-containing monomer can be at least one of styrene and α-methylstyrene. These resins easily interact with pigments, and thus can be used as resin dispersants for dispersing pigments. As the resin particle, a resin particle composed of an acrylic resin can be used. In order to ensure that the resin particle has hydrophobicity that is not too high, the resin particle composed of a resin free of a unit having a naphthalene structure can be used.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include acidic monomers having a carboxylic acid group, such as (meth)acrylic acid, itaconic acid, maleic acid and fumaric acid; and anionic monomers, such as anhydrides and salts of these acidic monomers. Examples of a cation constituting the salt of the acidic monomer include a lithium ion, a sodium ion, a potassium ion, an ammonium ion and organic ammonium ion. For the resin, one or more types of hydrophilic monomers can be used.

The hydrophobic unit is a unit having no hydrophilic group, such as an anionic group. The hydrophobic unit can be formed, for example, by polymerizing a hydrophobic monomer having no hydrophilic group, such as an anionic group. Specific examples of the hydrophobic monomer include monomers having an aromatic ring, such as styrene, α-methylstyrene and benzyl (meth)acrylate; and (meth)acrylic acid ester monomers, such as methyl (meth)acrylate, ethyl (meth)acrylate, butyl (meth)acrylate and 2-ethylhexyl (meth)acrylate. For the resin, one or more types of hydrophobic monomers can be used.

The urethane-based resin can be prepared, for example, by reacting a polyisocyanate with a polyol. The urethane-based resin may also be one that has been reacted with a chain extender. Examples of the olefin-based resin include polyethylene and polypropylene.

### Resin Properties

In the present specification, the term “resin particle” indicates that when the resin is neutralized with an alkali equivalent to the acid value, the resin is present in an aqueous medium in a state in which the resin is in the form of a particle having a particle size that can be measured by a dynamic light scattering method. In the present specification, the expression “a resin is water-soluble” indicates that when the resin is neutralized with an alkali equivalent to the acid value, the resin is present in an aqueous medium in a state in which the resin is not in the form of a particle having a particle size that can be measured by a dynamic light scattering method. Whether a particle is a resin particle can be determined according to a method described below. First, a liquid (resin solid content: 10% by mass) containing a resin neutralized with an alkali, such as sodium hydroxide or potassium hydroxide, equivalent to its acid value is provided. Subsequently, the prepared liquid is diluted 10 times (on a volume basis) with pure water to prepare a sample solution. Then, in the case where the particle size of the resin in the sample solution is measured by the dynamic light scattering method and where a particle having a particle size is measured, the resin can be determined to be a resin particle. When a particle having a particle size is not measured, the resin can be determined to be water-soluble. The measurement conditions at this time can be as follows: for example, SetZero: 30 seconds; the number of times of measurement: 3 times; and measurement time: 180 seconds. A particle size analyzer based on the dynamic light scattering method (e.g., trade name: “UPA-EX150”, manufactured by Nikkiso Co., Ltd.) or the like may be used as a particle size distribution measurement apparatus. Of course, the particle size distribution measurement apparatus, the measurement conditions and so forth are not limited to the foregoing.

The acid value of the water-soluble resin can be 100 mgKOH/g or more to 250 mgKOH/g or less. The weight-average molecular weight of the water-soluble resin can be 3,000 or more to 15,000 or less.

The acid value of the resin constituting the resin particle can be 5 mgKOH/g or more to 100 mgKOH/g or less. The weight-average molecular weight of the resin constituting the resin particle is preferably 1,000 or more to 3,000,000 or less, more preferably 100,000 or more to 3,000,000 or less. The 50% cumulative particle size (D₅₀) of the resin particle measured by a dynamic light scattering method on a volume basis can be 50 nm or more to 500 nm or less. The 50% cumulative particle size of the resin particle on a volume basis is a diameter of a particle at which the cumulative value from the small particle size side reaches 50% based on the total volume of the measured particle in a particle size cumulative curve. The 50% cumulative particle size of the resin particle on a volume basis can be measured based on the particle size analyzer and the measurement conditions by the dynamic light scattering method described above. The glass transition temperature of the resin particle is preferably 40° C. or higher to 120° C. or lower, more preferably 50° C. or higher to 100° C. or lower. The glass transition temperature (° C.) of the resin particle can be measured with a differential scanning calorimeter (DSC). The resin particle does not need to contain a coloring material.

### Wax Particle

The ink may contain a particle composed of wax (wax particle).

The use of the ink containing the wax particle can record an image having further improved abrasion resistance. The wax in the present specification may be a composition in which a component other than the wax is blended, or may be the wax itself. The wax particle may be dispersed by a dispersant, such as a surfactant or a resin. One type of wax may be used alone, or two or more types of waxes may be used in combination. The wax particle content (% by mass) of the ink is preferably 0.1% by mass or more to 10.0% by mass or less, more preferably 1.0% by mass or more to 5.0% by mass or less, based on the total mass of the ink.

In a narrow sense, the wax is an ester of a fatty acid with a higher monohydric alcohol or dihydric alcohol insoluble in water, and includes an animal wax and a vegetable wax but includes no oil or fat. In a broad sense, the wax includes a high-melting-point fat, a mineral-based wax, a petroleum-based wax and a blend and a modified product of various waxes. According to an embodiment of the present disclosure, any wax in a broad sense can be used without particular limitation. The wax in a broad sense can be classified into natural wax, synthetic wax, a blend thereof (blended wax) and a modified product thereof (modified wax).

Examples of the natural wax include animal-based wax, such as beeswax, spermaceti, or wool wax (lanolin); plant-based wax, such as Japan wax, carnauba wax, sugarcane wax, palm wax, candelilla wax, or rice wax; mineral-based wax, such as montan wax; and petroleum-based wax, such as paraffin wax, microcrystalline wax and petrolatum. Examples of the synthetic wax include hydrocarbon wax, such as Fischer-Tropsch wax and polyolefin wax, e.g., polyethylene wax and polypropylene wax. The blended wax is a mixture of the various waxes described above. The modified wax is prepared by subjecting the above-described various waxes to modification treatment, such as oxidation, hydrogenation, alcohol modification, acrylic modification or urethane modification. These waxes may be used alone or in combination of two or more. The wax can be at least one selected from the group consisting of microcrystalline wax, Fischer-Tropsch wax, polyolefin wax, paraffin wax, modified products thereof and blends thereof. Among these, a blend of a plurality of waxes can be used. A blend of petroleum-based wax and synthetic wax can be used.

The wax can be solid at room temperature (25° C.). The melting point (° C.) of the wax is preferably 40° C. or higher to 120° C. or lower, more preferably 50° C. or higher to 100° C. or lower. The melting temperature of the wax can be determined in accordance with a test method described in 5.3.1 (testing method for melting point) of JIS K 2235:1991 (Petroleum waxes). For microcrystalline wax, petrolatum and a mixture of a plurality of waxes, the melting point can be more accurately measured by a test method described in 5.3.2. The melting point of the wax is easily affected by properties, such as molecular weight (a higher molecular weight results in a higher melting point), molecular structure (a linear structure has a high melting point, and a branched structure has a lower melting point), crystallinity (a high crystallinity results in a higher melting point) and density (a higher density results in a higher melting point). Thus, wax having a desired melting point can be produced by controlling these properties. The melting point of the wax in the ink can be determined by, for example, subjecting the ink to ultracentrifugation treatment, washing and drying the separated wax, and then performing measurement in accordance with the above-described test method.

### Aqueous Medium

The ink is an aqueous ink containing at least water as an aqueous medium. The ink can contain water or an aqueous medium that is a mixed solvent of water and a water-soluble organic solvent. Deionized water or ion-exchanged water can be used as the water. The water content (% by mass) of the aqueous ink can be 50.0% by mass or more to 95.0% by mass or less based on the total mass of the ink. The water-soluble organic solvent content (% by mass) of the aqueous ink can be 2.0% by mass or more to 40.0% by mass or less based on the total mass of the ink. Examples of the water-soluble organic solvent include alcohol, (poly)alkylene glycol, glycol ether, a nitrogen-containing solvent and a sulfur-containing solvent, which can be used in an ink for ink jet recording. These water-soluble organic solvents may be used alone or in combination of two or more.

### Water-Soluble Hydrocarbon Compound

The water-soluble organic solvent incorporated into the ink can contain a specific water-soluble hydrocarbon compound. This water-soluble hydrocarbon compound is a compound that has a hydrocarbon chain having 3 or more carbon atoms and that is substituted with 2 or more hydrophilic groups selected from the group consisting of a hydroxy group, an amino group and an anionic group. However, the hydrocarbon chain may be interrupted by a sulfonyl group or an ether group. When the hydrocarbon chain has 3 or 4 carbon atoms, the hydrophilic group contains an anionic group or the hydrocarbon chain is interrupted by a sulfonyl group.

In an embodiment of the present disclosure, a hydrocarbon compound in the state of being dissolved in water at a compound content of the ink at 25° C. is defined as being “water-soluble”. That is, the solubility of the compound in water at 25° C. is larger than the compound content of the ink. The fact that the hydrocarbon chain is interrupted by a sulfonyl group or an ether group indicates that a sulfonyl group (—S(═O)₂—) or an ether group (—O—) is present in the middle of the hydrocarbon chain. The water-soluble hydrocarbon compound has a hydrogen-bonding group, such as a hydroxy group, an amino group, an anionic group, a sulfonyl group or an ether group. For this reason, the use of the ink containing the hydrocarbon compound can inhibit the cockling or curl of a recording medium on which an image has been recorded. A typical hydrocarbon compound having a hydrocarbon chain having a relatively small number of carbon atoms (3 or 4 carbon atoms) has a small molecular weight and tends to have a low vapor pressure. However, since the above-mentioned water-soluble hydrocarbon compound has a hydrogen-bonding anionic group or its hydrocarbon chain is interrupted by a sulfonyl group, the compound is less likely to evaporate owing to an intermolecular or intramolecular interaction and thus remains between fibers to provide the effect of inhibiting the cockling or curl. The water-soluble hydrocarbon compound content (% by mass) of the ink can be 1.0% by mass or more to 20.0% by mass or less based on the total mass of the ink.

The number of the carbon atoms of the hydrocarbon chain constituting the water-soluble hydrocarbon compound is preferably 3 or more to 50 or less, more preferably 3 or more to 10 or less. Examples of the anionic group include a sulfonic acid group and a carboxylic acid group. Specific examples of the water-soluble hydrocarbon compound include alkanediols, such as 1,5-pentanediol and 1,6-hexanediol; amino acids, such as alanine, β-alanine, trimethylglycine, amidosulfuric acid (alias: sulfamic acid), aminomethanesulfonic acid, taurine (synonym: 2-aminoethanesulfonic acid), carbamic acid, glycine, aspartic acid, glutamic acid, sulfanilic acid, salts of the acids described above, phenylalanine, leucine, isoleucine, threonine, tryptophan, valine, methionine, lysine and arginine; sulfonyl compounds, such as bis(2-hydroxyethyl)sulfone; alkylene glycols, such as triethylene glycol, tetraethylene glycol, tripropylene glycol and a polyethylene glycol having a number-average molecular weight of about 200 or more to about 1,000 or less; and sugars, such as sorbitol, D-sorbitol, xylitol, trehalose, fructose and D(+)-xylose. These water-soluble hydrocarbon compounds may be used alone or in combination two or more.

### Other Components

The ink may contain various other components as needed. Examples of the other components include various additives, such as a defoaming agent, a surfactant, a pH adjuster, a viscosity modifier, a rust inhibitor, a preservative, an antifungal agent, an antioxidant, and a reduction inhibitor. However, the ink need not contain the reactant contained in the reaction liquid.

### Physical Properties of Ink

The ink is an aqueous ink for use in the ink jet method. Thus, from the viewpoint of reliability, the physical property values can be appropriately controlled. The surface tension of the ink at 25° C. can be 20 mN/m or more to 60 mN/m or less. The viscosity of the ink at 25° C. can be 1.0 mPa·s or more to 10.0 mPa·s or less. The pH of the ink at 25° C. is preferably 7.0 or more to 9.5 or less, more preferably 8.0 or more to 9.5 or less.

According to an embodiment of the present disclosure, it is possible to provide an ink set including an aqueous ink and a maintenance liquid, the ink set being reliable, in particular, unlikely to cause ink discharge failure even when used continuously over a long period of time, and being capable of stably forming an image having good abrasion resistance. According to an embodiment of the present disclosure, it is also possible to provide an ink jet recording method using the ink set, an ink jet recording apparatus and a maintenance liquid that can be used for the ink jet recording method.

### EXAMPLES

While the present disclosure will be described in more detail with reference to examples and comparative examples, the present disclosure is not limited at all by the following examples as long as the gist of the present disclosure is not exceeded. Regarding the amount of component, “part(s)” and “%” are based on mass unless otherwise specified.

### Preparation of Reaction Liquid

The following components were mixed. The resulting mixtures were sufficiently stirred and subjected to pressure filtration through cellulose acetate filters (manufactured by Advantec Toyo Kaisha, Ltd.) having a pore size of 3.0 μm to prepare a reaction liquid.
Magnesium sulfate heptahydrate: 15.0%
Glycerin: 8.0%
Acetylenol E100 (surfactant manufactured by Kawaken Fine Chemicals Co., Ltd.): 1.0%
Ion-exchanged water: 76.0%
Preparation of Pigment Dispersion
Pigment Dispersion 1

A styrene-ethyl acrylate-acrylic acid copolymer (resin 1) having an acid value of 150 mgKOH/g and a weight-average molecular weight of 8,000 was provided. Then 20.0 parts of resin 1 was neutralized with potassium hydroxide in an amount equimolar to the acid value thereof. An appropriate amount of pure water was added thereto to prepare an aqueous solution of resin 1 having a resin content (solid content) of 20.0%. A mixture was prepared by mixing 10.0 parts of a pigment (C.I. Pigment Blue 15:3), 15.0 parts of the aqueous solution of resin 1 and 75.0 parts of pure water.

The resulting mixture and 200 parts of zirconia beads having a diameter of 0.3 mm were placed into a batch-type vertical sand mill (manufactured by Aimex Co., Ltd.) and dispersed for 5 hours while the sand mill was cooled with water. A coarse particle was removed by centrifugation, and then pressure filtration was performed with a cellulose acetate filter (manufactured by Advantec Toyo Kaisha, Ltd.) having a pore size of 3.0 μm. In this manner, pigment dispersion 1 was prepared, the pigment dispersion containing the pigment dispersed by the action of the anionic group of the resin dispersant, having a pigment content of 10.0% and a resin dispersant (resin 1) content of 3.0%.

### Pigment Dispersion 2

Pigment dispersion 2 having a pigment content of 10.0%, the pigment being dispersed by the action of the anionic group of the resin dispersant, and having a resin dispersant (resin 1) content of 3.0% was prepared by the same procedure as that for pigment dispersion 1 described above, except that the pigment was changed to C.I. Pigment Red 122.

### Pigment Dispersion 3

Pigment dispersion 3 having a pigment content of 10.0%, the pigment being dispersed by the action of the anionic group of the resin dispersant, and having a resin dispersant (resin 1) content of 3.0% was prepared by the same procedure as that for pigment dispersion 1 described above, except that the pigment was changed to C.I. Pigment Yellow 74.

### Pigment Dispersion 4

Pigment dispersion 4 having a pigment content of 10.0%, the pigment being dispersed by the action of the anionic group of the resin dispersant, and having a resin dispersant (resin 1) content of 3.0% was prepared by the same procedure as that for pigment dispersion 1 described above, except that the pigment was changed to carbon black.

### Pigment Dispersion 5

Pigment dispersion 5 was prepared by the same procedure as that for pigment dispersion 1 described above, except that resin 1 was changed to a styrene-2-hydroxyethyl acrylate copolymer (resin 2), which is a resin having no anionic group. Pigment dispersion 5 had a pigment content of 10.0% and a resin dispersant (resin 2) content of 3.0%.

### Preparation of Resin Particle

### Resin Particle 1

In a four-necked flask equipped with a stirrer, a reflux condenser and a nitrogen gas inlet, 0.2 parts of potassium persulfate and 74.0 parts of ion-exchanged water were mixed, thereby preparing a solution. Then 24.0 parts of ethyl methacrylate, 1.5 parts of methacrylic acid and 0.3 parts of a reactive surfactant (trade name: Aqualon KH-05, manufactured by DKS Co., Ltd.) were mixed to prepare an emulsion. The emulsion was added dropwise to the solution in the four-necked flask over one hour under a nitrogen atmosphere, and polymerization was performed under stirring at 80° C., followed by stirring for another two hours. After the mixture was cooled to 25° C., ion-exchanged water and an aqueous solution containing potassium hydroxide in an amount equimolar to the acid value of the resin particle were added thereto. Thereby, an aqueous dispersion of resin particle 1 was prepared, the resin particle containing an anionic group, and the aqueous dispersion having a resin particle content (solid content) of 25.0%.

### Resin Particle 2

In a four-necked flask equipped with a stirrer, a reflux condenser and a nitrogen gas inlet, 81.8 parts of ion-exchanged water and 0.2 parts of potassium persulfate were mixed. Then 16.1 parts of ethyl methacrylate, 1.6 parts of methoxy polyethylene glycol methacrylate and 0.3 parts of a reactive surfactant (trade name: Aqualon KH-05, manufactured by DKS Co., Ltd.) were mixed to prepare an emulsion. As the methoxy polyethylene glycol methacrylate, a compound available under the trade name “Blemmer PME-1000” (manufactured by NOF Corporation, the amount by mole of ethylene oxide groups added: about 23) was used. In a nitrogen atmosphere, the prepared emulsion was added dropwise to the four-necked flask over 1 hour. A polymerization reaction was performed at 80° C. for 2 hours under stirring. After the mixture was cooled to 25° C., ion-exchanged water and an aqueous solution containing potassium hydroxide in an amount equimolar to the acid value of the resin particle were added thereto. Thereby, an aqueous dispersion of resin particle 2 was prepared, the resin particle having no anionic group, and the aqueous dispersion having a resin particle content (solid content) of 25.0%.

### Preparation of Ink

Components (unit: %) given in Table 1 were mixed. The resulting mixtures were sufficiently stirred and subjected to pressure filtration through cellulose acetate filters (manufactured by Advantec Toyo Kaisha, Ltd.) having a pore size of 3.0 m to prepare respective inks. “AQUACER 515” is the trade name of a wax emulsion manufactured by BYK Chemie, and the wax particle content is 35% by mass. “Acetylenol E100” is the trade name of a surfactant manufactured by Kawaken Fine Chemicals Co., Ltd.

TABLE 1
Ink composition

| | Ink | | | | | | | | |
|---|---|---|---|---|---|---|---|---|---|
| | 1 | 2 | 3 | 4 | 5 | 6 | 7 | 8 | 9 |
| Pigment dispersion 1 | 40.00 | | | | 40.00 | | 40.00 | | 40.00 |
| Pigment dispersion 2 | | 40.00 | | | | | | | |
| Pigment dispersion 3 | | | 40.00 | | | | | | |
| Pigment dispersion 4 | | | | 40.00 | | | | | |
| Pigment dispersion 5 | | | | | | 40.00 | | 40.00 | |
| Aqueous dispersion | 40.00 | 40.00 | 40.00 | 40.00 | 40.00 | 40.00 | | | |
| of resin particle 1 | | | | | | | | | |
| Aqueous dispersion | | | | | | | 40.00 | 40.00 | |
| of resin particle 2 | | | | | | | | | |
| AQUACER 515 | 2.86 | 2.86 | 2.86 | 2.86 | | 2.86 | 2.86 | 2.86 | 2.86 |
| Glycerin | 15.00 | 15.00 | 15.00 | 15.00 | 15.00 | 15.00 | 15.00 | 15.00 | 15.00 |
| 1,2-Hexanediol | 1.00 | 1.00 | 1.00 | 1.00 | 1.00 | 1.00 | 1.00 | 1.00 | 1.00 |
| Acetylenol E100 | 0.50 | 0.50 | 0.50 | 0.50 | 0.50 | 0.50 | 0.50 | 0.50 | 0.50 |
| Ion-exchanged water | 0.64 | 0.64 | 0.64 | 0.64 | 3.50 | 0.64 | 0.64 | 0.64 | 40.64 |

### Preparation of Maintenance Liquid

Components (unit: %) given in Table 2 (Tables 2-1 to 2-4) were mixed. The resulting mixtures were sufficiently stirred and subjected to pressure filtration through cellulose acetate filters (manufactured by Advantec Toyo Kaisha, Ltd.) having a pore size of 3.0 m to prepare respective maintenance liquids. “BYK 3420” is a trade name of a silicone-based surfactant manufactured by BYK Chemie. The dynamic surface tension value of each maintenance liquid was measured at 25° C. and a lifetime of 10 ms with a dynamic surface tensiometer (trade name: “Bubble Pressure Tensiometer BP-100”, manufactured by KRUSS) based on a maximum bubble pressure method.

TABLE 2-1
Composition and characteristics of maintenance liquid

| | Maintenance liquid | | | | | | |
|---|---|---|---|---|---|---|---|
| | 1 | 2 | 3 | 4 | 5 | 6 | 7 |
| 3-Amino-1-propanesulfonic | | | | 0.30 | | | |
| acid (pKa1 = 1.1) | | | | | | | |
| 2-Aminoethanesulfonic | 0.30 | | | | 0.05 | 0.10 | 1.00 |
| acid (pKa1 = 1.5) | | | | | | | |
| 3-Aminobenzenesulfonic | | 0.30 | | | | | |
| acid (pKa1 = 3.7) | | | | | | | |
| Aminomethanesulfonic | | | 0.30 | | | | |
| acid (pKa1 = 5.6) | | | | | | | |
| Alanine (pKa1 = 2.4) | | | | | | | |
| 1,3-Butanediol | | | | | | | |
| (SP value = 14.8) | | | | | | | |
| 1,5-Pentanediol | 5.00 | 5.00 | 5.00 | 5.00 | 5.00 | 5.00 | 5.00 |
| (SP value = 14.2) | | | | | | | |
| Propylene glycol | | | | | | | |
| (SP value = 13.5) | | | | | | | |
| 3-Methyl-1,5-pentanediol | | | | | | | |
| (SP value = 13.4) | | | | | | | |
| 1,2-Hexanediol | | | | | | | |
| (SP value = 11.8) | | | | | | | |
| Diethylene glycol monobutyl | | | | | | | |
| ether (SP value = 10.5) | | | | | | | |
| Glycerin | | | | | | | |
| (SP value = 16.4) | | | | | | | |
| BYK 3420 | 0.70 | 0.70 | 0.70 | 0.70 | 0.70 | 0.70 | 0.70 |
| Acetylenol E100 | | | | | | | |
| 8N KOH (pH adjuster) | 0.30 | 0.30 | 0.30 | 0.30 | 0.05 | 0.10 | 1.00 |
| Ion-exchanged water | 93.70 | 93.70 | 93.70 | 93.70 | 94.20 | 94.10 | 92.30 |
| Aminosulfonic acid | 0.30 | 0.30 | 0.30 | 0.30 | 0.05 | 0.10 | 1.00 |
| content [%] | | | | | | | |
| pH (25° C.) | 9.5 | 9.5 | 9.5 | 9.5 | 9.5 | 9.5 | 9.5 |
| Dynamic surface tension | 55 | 55 | 55 | 55 | 55 | 55 | 55 |
| [mN/m] (25° C.) | | | | | | | |

TABLE 2-2
Composition and characteristics of maintenance liquid

| | Maintenance liquid | | | | | | |
|---|---|---|---|---|---|---|---|
| | 8 | 9 | 10 | 11 | 12 | 13 | 14 |
| 3-Amino-1-propanesulfonic | | | | | | | |
| acid (pKa1 = 1.1) | | | | | | | |
| 2-Aminoethanesulfonic | 1.10 | 0.30 | 0.30 | 0.30 | 0.30 | 0.30 | 0.30 |
| acid (pKa1 = 1.5) | | | | | | | |
| 3-Aminobenzenesulfonic | | | | | | | |
| acid (pKa1 = 3.7) | | | | | | | |
| Aminomethanesulfonic | | | | | | | |
| acid (pKa1 = 5.6) | | | | | | | |
| Alanine (pKa1 = 2.4) | | | | | | | |
| 1,3-Butanediol | | | | | | | |
| (SP value = 14.8) | | | | | | | |
| 1,5-Pentanediol | 5.00 | 5.00 | 5.00 | 5.00 | 5.00 | 5.00 | 5.00 |
| (SP value = 14.2) | | | | | | | |
| Propylene glycol | | | | | | | |
| (SP value = 13.5) | | | | | | | |
| 3-Methyl-1,5-pentanediol | | | | | | | |
| (SP value = 13.4) | | | | | | | |
| 1,2-Hexanediol | | | | | | | |
| (SP value = 11.8) | | | | | | | |
| Diethylene glycol monobutyl | | | | | | | |
| ether (SP value = 10.5) | | | | | | | |
| Glycerin | | | | | | | |
| (SP value = 16.4) | | | | | | | |
| BYK 3420 | 0.70 | 0.70 | 0.70 | 0.70 | 0.70 | | |
| Acetylenol E100 | | | | | | 0.30 | 0.20 |
| 8N KOH (pH adjuster) | 1.10 | 0.00 | 0.005 | 1.50 | 1.90 | 0.30 | 0.30 |
| Ion-exchanged water | 92.10 | 94.00 | 93.995 | 92.50 | 92.10 | 94.10 | 94.20 |
| Aminosulfonic acid | 1.10 | 0.30 | 0.30 | 0.30 | 0.30 | 0.30 | 0.30 |
| content [%] | | | | | | | |
| pH (25° C.) | 9.5 | 5.5 | 7.3 | 11.7 | 12.1 | 9.5 | 9.5 |
| Dynamic surface tension | 55 | 55 | 55 | 55 | 55 | 40 | 45 |
| [mN/m] (25° C.) | | | | | | | |

TABLE 2-3
Composition and characteristics of maintenance liquid

| | Maintenance liquid | | | | | | |
|---|---|---|---|---|---|---|---|
| | 15 | 16 | 17 | 18 | 19 | 20 | 21 |
| 3-Amino-1-propanesulfonic | | | | | | | |
| acid (pKa1 = 1.1) | | | | | | | |
| 2-Aminoethanesulfonic | 0.30 | 0.30 | 0.30 | 0.30 | 0.30 | 0.30 | 0.30 |
| acid (pKa1 = 1.5) | | | | | | | |
| 3-Aminobenzenesulfonic | | | | | | | |
| acid (pKa1 = 3.7) | | | | | | | |
| Aminomethanesulfonic | | | | | | | |
| acid (pKa1 = 5.6) | | | | | | | |
| Alanine (pKa1 = 2.4) | | | | | | | |
| 1,3-Butanediol | | | | | | | |
| (SP value = 14.8) | | | | | | | |
| 1,5-Pentanediol | 5.00 | | 1.00 | 2.00 | 10.00 | 11.00 | |
| (SP value = 14.2) | | | | | | | |
| Propylene glycol | | | | | | | |
| (SP value = 13.5) | | | | | | | |
| 3-Methyl-1,5-pentanediol | | | | | | | |
| (SP value = 13.4) | | | | | | | |
| 1,2-Hexanediol | | | | | | | |
| (SP value = 11.8) | | | | | | | |
| Diethylene glycol monobutyl | | | | | | | 5.00 |
| ether (SP value = 10.5) | | | | | | | |
| Glycerin | | | | | | | |
| (SP value = 16.4) | | | | | | | |
| BYK 3420 | | 0.70 | 0.70 | 0.70 | 0.70 | 0.70 | 0.70 |
| Acetylenol E100 | | | | | | | |
| 8N KOH (pH adjuster) | 0.30 | 0.30 | 0.30 | 0.30 | 0.30 | 0.30 | 0.30 |
| Ion-exchanged water | 94.40 | 98.70 | 97.70 | 96.70 | 88.70 | 87.70 | 93.70 |
| Aminosulfonic acid | 0.30 | 0.30 | 0.30 | 0.30 | 0.30 | 0.30 | 0.30 |
| content [%] | | | | | | | |
| pH (25° C.) | 9.5 | 9.5 | 9.5 | 9.5 | 9.5 | 9.5 | 9.5 |
| Dynamic surface tension | 62 | 62 | 60 | 60 | 55 | 55 | 33 |
| [mN/m] (25° C.) | | | | | | | |

TABLE 2-4
Composition and characteristics of maintenance liquid

| | Maintenance liquid | | | | | | |
|---|---|---|---|---|---|---|---|
| | 22 | 23 | 24 | 25 | 26 | 27 | 28 |
| 3-Amino-1-propanesulfonic | | | | | | | |
| acid (pKa1 = 1.1) | | | | | | | |
| 2-Aminoethanesulfonic | 0.30 | 0.30 | 0.30 | 0.30 | 0.30 | | |
| acid (pKa1 = 1.5) | | | | | | | |
| 3-Aminobenzenesulfonic | | | | | | | |
| acid (pKa1 = 3.7) | | | | | | | |
| Aminomethanesulfonic | | | | | | | |
| acid (pKa1 = 5.6) | | | | | | | |
| Alanine (pKa1 = 2.4) | | | | | | | 0.30 |
| 1,3-Butanediol | 5.00 | | | | | | |
| (SP value = 14.8) | | | | | | | |
| 1,5-Pentanediol | | | | | | 5.00 | 5.00 |
| (SP value = 14.2) | | | | | | | |
| Propylene glycol | | 5.00 | | | | | |
| (SP value = 13.5) | | | | | | | |
| 3-Methyl-1,5-pentanediol | | | 5.00 | | | | |
| (SP value = 13.4) | | | | | | | |
| 1,2-Hexanediol | | | | 5.00 | | | |
| (SP value = 11.8) | | | | | | | |
| Diethylene glycol monobutyl | | | | | | | |
| ether (SP value = 10.5) | | | | | | | |
| Glycerin | | | | | 5.00 | | |
| (SP value = 16.4) | | | | | | | |
| BYK 3420 | 0.70 | 0.70 | 0.70 | 0.70 | 0.70 | 0.70 | 0.70 |
| Acetylenol E100 | | | | | | | |
| 8N KOH (pH adjuster) | 0.30 | 0.30 | 0.30 | 0.30 | 0.30 | 0.002 | 0.30 |
| Ion-exchanged water | 93.70 | 93.70 | 93.70 | 93.70 | 93.70 | 94.298 | 93.70 |
| Aminosulfonic acid | 0.30 | 0.30 | 0.30 | 0.30 | 0.30 | 0.00 | 0.00 |
| content [%] | | | | | | | |
| pH (25° C.) | 9.5 | 9.5 | 9.5 | 9.5 | 9.5 | 9.5 | 9.5 |
| Dynamic surface tension | 55 | 55 | 50 | 33 | 60 | 55 | 55 |
| [mN/m] (25° C.) | | | | | | | |

### Evaluation

An image was recorded on a recording medium according to the evaluation conditions presented on the left side of Table 3 with an ink jet recording apparatus 100 having the configuration illustrated in FIG. 1. The reaction liquid applying device 1201 of the ink jet recording apparatus 100 was filled with the above-described reaction liquid. The ink applying device 1202 and the maintenance liquid pack 101 (see FIG. 7) of the ink jet recording apparatus 100 were filled with the ink and the maintenance liquid, respectively, numbered as presented on the left side of Table 3. The reaction liquid was applied to the recording medium by an ink jet method before application of the ink. The ink was also applied to the recording medium by the ink jet method. A solid image having a size of 1.5 cm×13 cm was recorded on a recording medium (trade name “OK Topcoat+”, manufactured by Oji Paper Co., Ltd.) by applying the reaction liquid in an amount of 2 g/m² and the ink in an amount of 8 g/m² to the recording medium. In the heating portion 2000 before the fixing portion 3000 of the ink jet recording apparatus 100, the temperature of the warm air and the conveying speed of the recording medium were adjusted in such a manner that warm air at 80° C. was applied to the recording medium for 2 seconds. In the fixing portion 3000, a pressure (fixing pressure (Pa)) applied to the recording medium by a contact-type heat and pressure-applying mechanism was controlled by adjusting the spring pressure for adjusting the pressure, and the image was fixed to the recording medium at a nip pressure of 20 Pa, a nip time of 2 seconds and a heating temperature of 85° C.

The recorded images were evaluated as described below. In examples, for the following evaluation criteria for each item, “A” and “B” were defined as acceptable levels, and “C” was defined as an unacceptable level. The evaluation results are presented on the right side of Table 3.

### Abrasion Resistance

The recorded image was left for 24 hours in an environment at a temperature of 25° C. and a relative humidity of 55%, and then rubbed 10 times with a load of 500 g using an abrasion resistance tester (Japan Society for the Promotion of Science type, trade name: “AB-301”, manufactured by Tester Sangyo Co., Ltd.). A recording medium of the same type as the recording medium on which the image has been recorded was attached as an evaluation recording medium to a friction block portion. After rubbing, the surface of the image and the surface of evaluation recording medium were visually observed. The image of abrasion resistance was evaluated according to the evaluation criteria described below.

A: The image was fixed on the recording medium, the white background of the recording medium was not seen, and the evaluation recording medium was not stained.
B: The image was fixed on the recording medium, the white background of the recording medium was not seen, and the evaluation recording medium was stained.
C: The image was peeled off from the recording medium, and the white background of the recording medium was seen.
Removability of Sticking Matter from Discharge Port Surface of Liquid Applying Device

The ink was sprayed in mist form onto the discharge port surface of the liquid applying device using a nebulizer. The liquid applying device was then placed in an oven at 46° C. and left there for 30 minutes. Thereafter, cleaning was performed to remove the ink solidified on the discharge port surface using any one of the following cleaning conditions 1 to 4. The discharge port surface of the liquid applying device was then observed. The removability of the sticking matter from the discharge port surface was evaluated according to the following evaluation criteria.

A: Sticking matter was observed in less than 5% of all discharge ports.
B: Sticking matter was observed in 5% or more to less than 10% of all discharge ports.
C: Sticking matter was observed in 10% or more of all discharge ports.

### Cleaning Condition 1

Maintenance Liquid Applying Device: Yes
Wiper: Yes
Ink Suction: Yes

To the discharge element substrate including the discharge port surface of the liquid applying device, 0.4 g of the maintenance liquid was applied using the maintenance liquid applying device. The discharge port surface of the liquid applying device was wiped with a wiper blade of a liquid removing device (scanning speed: 80 mm/s), and then the ink was suctioned with a negative pressure applying device (negative pressure: −40 kPa or less, and scanning speed: 5.6 mm/s), thereby cleaning the discharge port surface.

### Cleaning Condition 2

Maintenance Liquid Applying Device: No
Wiper: Yes
Ink Suction: Yes

To the wiper blade of the liquid removing device, 0.4 g of the maintenance liquid was applied. The maintenance liquid was applied to the discharge element substrate including the discharge port surface of the liquid applying device with the wiper blade, and at the same time, the discharge port surface was wiped with the wiper blade (scanning speed: 80 mm/s). Thereafter, the ink was suctioned with the negative pressure applying device (negative pressure: −40 kPa or less, and scanning speed: 5.6 mm/s), thereby cleaning the discharge port surface.

### Cleaning Condition 3

Maintenance Liquid Applying Device: Yes
Wiper: Yes
Ink Suction: No

To the discharge element substrate including the discharge port surface of the liquid applying device, 0.4 g of the maintenance liquid was applied using the maintenance liquid applying device. The discharge port surface of the liquid applying device was then wiped (scanning speed: 80 mm/s) with a wiper blade of the liquid removing device, thereby cleaning the discharge port surface.

### Cleaning Condition 4

Maintenance Liquid Applying Device: Yes
Wiper: No
Ink Suction: Yes

To the discharge element substrate including the discharge port surface of the liquid applying device, 0.4 g of the maintenance liquid was applied using the maintenance liquid applying device. Thereafter, the ink was suctioned with the negative pressure applying device (negative pressure: −40 kPa or less, and scanning speed: 5.6 mm/s), thereby cleaning the discharge port surface.

### Recoverability After Leaving Ink Applying Device Capped

The Ink was filled into the ink applying device 1202. Then, using the ink jet recording apparatus 100 having the configuration illustrated in FIG. 1, the discharge of the ink from the discharge ports of each ink applying device was verified with a pattern used to verify the presence or absence of discharge from all discharge ports. The ink applying device filled with the ink was capped using a cap having a cap absorbent impregnated with 20 g of maintenance liquid and left for two weeks in an environment having a temperature of 30° C. and a relative humidity of 10%. After two weeks, the ink was circulated as a recovery operation in the ink applying device of the ink jet recording apparatus. The pattern to verify the discharge state of all discharge ports was then recorded. The recoverability after the ink applying device was left capped was evaluated according to the following evaluation criteria.

A: The number of discharge ports that failed to discharge the ink was less than 5% of all discharge ports.
B: The number of discharge ports that failed to discharge the ink was 5% or more to less than 10% of all discharge ports.
C: The number of discharge ports that failed to discharge the ink was 10% or more of all discharge ports.

### Deposition Due to Preliminary Discharge

The cap absorbent was impregnated with 20 g of the maintenance liquid. In the ink jet recording apparatus 100 having the configuration illustrated in FIG. 1, the operation of discharging the ink into the cap 30 times from all the discharge ports and pausing for 5 minutes was repeated 100 times. Thereafter, the state of the ink deposition on the cap absorbent was observed. The deposition due to the preliminary discharge was evaluated according to the following evaluation criteria.

A: No ink was deposited.
B: The ink was deposited on the cap absorbent, but when the ink applying device was capped, the deposit did not adhere to the discharge port surface of the ink applying device.
C: The ink was deposited on the cap absorbent, and when the ink applying device was capped, the deposit adhered to the discharge port surface of the ink applying device.

### Solidification in Tube

After 50 g of the ink was passed through a tube, 50 g of the maintenance liquid was passed through the tube. The tube was left in an open state for 5 days in an environment of a temperature of 30° C. and a relative humidity of 10%. Thereafter, 50 g of ink was passed through the tube, and solidification in the tube was evaluated according to the following criteria.

A: The flow path was not clogged, and the ink passed through.
B: Although there was a blockage in the flow path, the ink passed through.
C: The ink did not pass through due to a blockage in the flow path.

TABLE 3
Evaluation conditions and evaluation results

| | | | | | Evaluation items | | | | |
|---|---|---|---|---|---|---|---|---|---|
| | | Evaluation conditions | | | | Removability of | Recoverability | Deposition | |
| | | | | Cleaning | | sticking matter | after leaving ink | due to | |
| | | Maintenance | Ink | condition | Abrasion | from discharge | applying device | preliminary | Solidification |
| | | liquid No. | No. | No. | resistance | port surface | capped | discharge | in tube |
| Example | 1 | 1 | 1 | 1 | A | A | A | A | A |
| | 2 | 1 | 2 | 1 | A | A | A | A | A |
| | 3 | 1 | 3 | 1 | A | A | A | A | A |
| | 4 | 1 | 4 | 1 | A | A | A | A | A |
| | 5 | 2 | 1 | 1 | A | B | A | A | A |
| | 6 | 3 | 1 | 1 | A | B | A | A | A |
| | 7 | 4 | 1 | 1 | A | B | A | A | A |
| | 8 | 5 | 1 | 1 | A | B | A | A | A |
| | 9 | 6 | 1 | 1 | A | A | A | A | A |
| | 10 | 7 | 1 | 1 | A | A | A | A | A |
| | 11 | 8 | 1 | 1 | A | B | A | A | A |
| | 12 | 9 | 1 | 1 | A | B | A | A | A |
| | 13 | 10 | 1 | 1 | A | A | A | A | A |
| | 14 | 11 | 1 | 1 | A | A | A | A | A |
| | 15 | 12 | 1 | 1 | A | B | A | A | A |
| | 16 | 13 | 1 | 1 | A | B | A | A | A |
| | 17 | 14 | 1 | 1 | A | A | A | A | A |
| | 18 | 15 | 1 | 1 | A | A | A | A | A |
| | 19 | 16 | 1 | 1 | A | B | B | B | B |
| | 20 | 17 | 1 | 1 | A | A | B | B | B |
| | 21 | 18 | 1 | 1 | A | A | A | A | A |
| | 22 | 19 | 1 | 1 | A | A | A | A | A |
| | 23 | 20 | 1 | 1 | A | A | B | A | A |
| | 24 | 21 | 1 | 1 | A | A | B | B | B |
| | 25 | 22 | 1 | 1 | A | A | A | A | A |
| | 26 | 23 | 1 | 1 | A | A | A | A | A |
| | 27 | 24 | 1 | 1 | A | A | A | A | A |
| | 28 | 25 | 1 | 1 | A | A | A | A | A |
| | 29 | 26 | 1 | 1 | A | B | A | A | A |
| | 30 | 1 | 5 | 1 | B | A | A | A | A |
| | 31 | 1 | 1 | 2 | A | B | A | A | A |
| | 32 | 1 | 1 | 3 | A | B | A | A | A |
| | 33 | 1 | 1 | 4 | A | B | A | A | A |
| Comparative | 1 | 27 | 1 | 1 | A | C | A | A | A |
| Example | 2 | 28 | 1 | 1 | A | C | A | A | A |
| | 3 | 1 | 6 | 1 | A | C | A | A | A |
| | 4 | 1 | 7 | 1 | A | C | A | A | A |
| | 5 | 1 | 8 | 1 | A | C | A | A | A |
| Reference | 1 | 1 | 9 | 1 | A | A | A | A | A |
| Example | 2 | 27 | 9 | 1 | A | A | A | A | A |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-140546 filed Aug. 30, 2023 and No. 2024-129770 filed Aug. 6, 2024, which are hereby incorporated by reference herein in their entirety.

What is claimed is:

1. An ink set, comprising:
an aqueous ink; and
a maintenance liquid used together with the aqueous ink,
wherein the aqueous ink comprises:
a pigment, and
a resin particle having an anionic group, the pigment and the resin particle being dispersed by action of the anionic group, and
wherein the maintenance liquid comprises an aminosulfonic acid.

2. The ink set according to claim 1, wherein the aminosulfonic acid has a pKa1 of 2.0 or less.

3. The ink set according to claim 1, wherein the aminosulfonic acid is 2-aminoethanesulfonic acid.

4. The ink set according to claim 1, wherein the amount (% by mass) of the aminosulfonic acid contained in the maintenance liquid is 0.1% by mass or more to 1.0% by mass or less based on the total mass of the maintenance liquid.

5. The ink set according to claim 1, wherein the maintenance liquid has a pH of 7.0 or more to 12.0 or less at 25° C.

6. The ink set according to claim 1, wherein the maintenance liquid has a dynamic surface tension of 45 mN/m or more at 25° C. and a lifetime of 10 ms.

7. The ink set according to claim 1, wherein the maintenance liquid comprises a water-soluble organic solvent.

8. The ink set according to claim 7, wherein the amount (% by mass) of the water-soluble organic solvent contained in the maintenance liquid is 2.0% by mass or more to 10.0% by mass or less based on the total mass of the maintenance liquid.

9. The ink set according to claim 7, wherein the water-soluble organic solvent has a solubility parameter value (unit: (cal/cm³)^{1/2}) of 11.0 or more to 15.0 or less, the SP value being determined by Fedors' method.

10. The ink set according to claim 1, wherein the aqueous ink comprises a wax particle.

11. An ink jet recording method, comprising:
using an ink set including:
an aqueous ink, and
a maintenance liquid used together with the aqueous ink,
wherein the aqueous ink comprises:
a pigment, and
a resin particle having an anionic group, the pigment and the resin particle being dispersed by action of the anionic group, and
wherein the maintenance liquid comprises an aminosulfonic acid.

12. The ink jet recording method according to claim 11, further comprising the steps of:
discharging the aqueous ink from a discharge port of a liquid applying device to record an image on a recording medium;
applying the maintenance liquid to a discharge port surface of the liquid applying device, the discharge port surface including the discharge port; and
cleaning the discharge port surface of the liquid applying device,
wherein after the step of applying the maintenance liquid to the discharge port surface, the step of cleaning the discharge port surface is performed.

13. The ink jet recording method according to claim 12, wherein in the step of cleaning the discharge port surface of the liquid applying device, the discharge port surface is cleaned with a wiper blade and by application of a negative pressure.

14. An ink jet recording apparatus, comprising:
an ink set including:
an aqueous ink, and
a maintenance liquid used together with the aqueous ink,
wherein the aqueous ink comprises:
a pigment, and
a resin particle having an anionic group, the pigment and the resin particle being dispersed by action of the anionic group, and
wherein the maintenance liquid comprises an aminosulfonic acid.

15. A maintenance liquid for use in an ink jet recording method using an ink set including an aqueous ink and the maintenance liquid used together with the aqueous ink, the maintenance liquid comprising:
an aminosulfonic acid,
wherein the aqueous ink comprises:
a pigment, and
a resin particle having an anionic group, the pigment and the resin particle being dispersed by action of the anionic group.
